(19) United States
(12) Patent Application Publication
(10) Pub. No.: US 2026/0282094 A1
(43) Pub. Date: Sep. 17, 2026

(54) METHOD AND APPARATUS FOR PERFORMING REVERSE DIRECTION TRANSMISSION IN WLAN

(71) Applicant: HOLISTIC MANIFOLD INC., Daejeon (KR)

(72) Inventors: Yongho KIM, Incheon (KR); Woojin AHN, Anyang-si (KR); Juseong MOON, Osan-si (KR)

(73) Assignee: HOLISTIC MANIFOLD INC., Daejeon (KR)

(21) Appl. No.: 19/676,099

(22) Filed: May 13, 2026

Related U.S. Application Data
(63) Continuation of application No. PCT/KR2024/017918, filed on Nov. 13, 2024.

(30) Foreign Application Priority Data
Nov. 13, 2023 (KR) 10-2023-0156465
Jul. 5, 2024 (KR) 10-2024-0089040

(51) Int. Cl. H04W 74/0816; H04L 5/00; H04W 28/02; H04W 84/12

(52) U.S. Cl. CPC H04W 74/0816; H04L 5/0053; H04W 28/0278; H04W 84/12

(57) ABSTRACT

A method of operating an access point (AP) in a wireless LAN system, the method comprising: receiving a first frame from a first station (STA) indicating grant of reverse direction communication; determining a reverse direction communication period based on a transmission opportunity (TXOP) of the first STA when the first frame indicates grant of the reverse direction communication; transmitting at least one frame to a second STA within the reverse direction communication period; and terminating the reverse direction communication upon completing transmission of a last frame among the at least one frame transmitted to the second STA or upon expiration of the reverse direction communication period.

### CROSS REFERENCE TO RELATED APPLICATIONS

This application is a bypass continuation application of International Application No. PCT/KR2024/017918, filed on Nov. 13, 2024, which claims priority to Korean Patent Application No. 10-2023-0156465, filed on Nov. 13, 2023, and Korean Patent Application No. 10-2024-0089040, filed on Jul. 5, 2024, the disclosures of which are incorporated herein by reference in their entireties.

### FIELD

The present disclosure relates to a method and apparatus for performing reverse direction transmission in a Wireless Local Area Network (WLAN). Specifically, the present disclosure relates to a method and apparatus for performing artificial intelligence (AI)-based reverse direction communication in a WLAN.

The present disclosure also relates to a method and apparatus for a multi-link single radio station (STA) to exchange frames based on artificial intelligence in a WLAN.

### DESCRIPTION OF THE RELATED ART

With the recent widespread adoption of mobile devices, wireless local area network (WLAN) technology capable of providing fast wireless communication services to mobile devices has been receiving significant attention. WLAN technology may refer to technology that enables mobile devices, such as smartphones, smart pads, laptop computers, portable multimedia players, and embedded devices, to wirelessly access the Internet based on short-range wireless communication technology.

Standards utilizing WLAN technology are primarily developed by the Institute of Electrical and Electronics Engineers (IEEE) as the IEEE 802.11 standard. As the WLAN technology has been developed and commercialized, applications utilizing WLAN technology have diversified, and the demand for WLAN technology supporting higher reliability has emerged. Recently, as applications requiring higher reliability have emerged, the IEEE 802.11bn standard, which is an Ultra High Reliability (UHR) WLAN technology, is being developed for use in single Basic Service Set (BSS) environments and/or overlapping BSS environments.

The objectives of the IEEE 802.11bn standard may include supporting improvements in data transmission rate, latency performance, and data error rate. In addition, the IEEE 802.11bn standard may support low-power operation and peer-to-peer (P2P) communication. In a WLAN, a plurality of terminals may utilize wireless resources.

However, as the number of wireless terminals utilizing wireless resources increases, communication delays due to channel access may occur, and inefficient use of wireless resources may arise. That is, issues with the performance of the WLAN network may occur.

Meanwhile, the background art section has been prepared to promote understanding of the background of the invention. It may include content that is not prior art already known to those skilled in the art to which this technology pertains, and may not be limited to any specific form.

### SUMMARY

The present disclosure may provide a method and apparatus for performing reverse direction communication in a WLAN.

The present disclosure may provide a method and apparatus for determining a reverse direction communication period in a WLAN.

The present disclosure may provide a method and apparatus for revoking a reverse direction communication period in a WLAN.

The present disclosure may provide a method and apparatus for performing a reverse direction communication membership negotiation procedure in a WLAN.

The present disclosure may provide a method and apparatus for reducing latency based on artificial intelligence and performing reverse direction communication based on efficient wireless resource utilization in a WLAN.

The present disclosure may provide a method for enabling a WLAN terminal to perform Enhanced Multi-Link Single Radio (EMLSR) operation and to transition to a listen operation, which is an operational state of the EMLSR operation, after the WLAN terminal transmits a frame not requiring a response to a wireless access point.

The technical problems to be achieved in the present disclosure are not limited to the technical problems mentioned above, and other technical problems not mentioned herein will be clearly understood by those skilled in the art to which the present disclosure pertains from the description below.

According to an embodiment of the present disclosure, a method of operating an access point (AP) in a wireless LAN system may comprise: receiving a first frame from a first station (STA) indicating grant of reverse direction communication; determining a reverse direction communication period based on a transmission opportunity (TXOP) of the first STA when the first frame indicates grant of reverse direction communication; transmitting at least one frame to a second STA within the reverse direction communication period; and terminating the reverse direction communication upon completing transmission of a last frame among the at least one frame transmitted to the second STA or upon expiration of the reverse direction communication period.

According to an embodiment of the present disclosure, a wireless user equipment may comprise: at least one processor; and a memory storing instructions that cause the wireless user equipment to perform certain operations by the at least one processor, wherein the certain operations comprise: receiving a first frame from a first station (STA) indicating grant of reverse direction communication; determining a reverse direction communication period based on a transmission opportunity (TXOP) of the first STA when the first frame indicates grant of reverse direction communication; transmitting at least one frame to a second STA within the reverse direction communication period; and terminating the reverse direction communication upon completing transmission of a last frame among the at least one frame transmitted to the second STA or upon expiration of the reverse direction communication period.

According to an embodiment of the present disclosure, a method of operating a station (STA) in a wireless LAN system may comprise: transmitting a first frame including a reverse direction grant (RDG) indicator indicating whether reverse direction communication is granted to an access point (AP); and transmitting data when a data transmission enabling condition is satisfied, wherein the reverse direction grant indicator transmitted to the AP is used by the AP for at least one of: determining a reverse direction communication period based on a transmission opportunity (TXOP) of the wireless user equipment; and determining whether to initiate a procedure for transmitting at least one frame to another STA based on the determined reverse direction communication period, and wherein the data transmission enabling condition is that the reverse direction communication is terminated by the AP upon completing transmission of a last frame among the at least one frame or upon expiration of the reverse direction communication period.

According to an embodiment of the present disclosure, a wireless user equipment may comprise: at least one processor; and a memory storing instructions that cause the wireless user equipment to perform certain operations by the at least one processor, wherein the certain operations comprise: transmitting a first frame including a reverse direction grant (RDG) indicator indicating whether reverse direction communication is granted to an access point (AP); and transmitting data when a data transmission enabling condition is satisfied, wherein the reverse direction grant indicator transmitted to the AP is used by the AP for at least one of: determining a reverse direction communication period based on a transmission opportunity (TXOP) of the wireless user equipment; and determining whether to initiate a procedure for transmitting at least one frame to another STA based on the determined reverse direction communication period, and wherein the data transmission enabling condition is that the reverse direction communication is terminated by the AP upon completing transmission of a last frame among the at least one frame or upon expiration of the reverse direction communication period.

In addition, the following may be commonly applied.

According to an embodiment of the present disclosure, the first frame may include a reverse direction grant (RDG) indicator indicating whether reverse direction communication is granted, an access category (AC) restriction indicator indicating whether the access category (AC) of data is restricted, and an AC of the first STA data, wherein when the RDG indicator indicates grant of reverse direction communication, the first frame further includes a reverse direction grant others (RDGO) indicator indicating whether data transmission to a STA other than the first STA grant reverse direction communication is permitted, and wherein when the AC restriction indicator permits transmission of data having an AC different from the AC of the first STA data in the reverse direction communication, the first frame further includes a TXOP extension grant indicator indicating whether extension of the reverse direction communication period is permitted.

According to an embodiment of the present disclosure, the AP may initiate reverse direction communication by transmitting a response frame including information indicating initiation of reverse direction communication to the first STA, and when the AP transmits at least one frame to a second STA different from the first STA based on the RDGO indicator, the at least one frame may include a more data indicator indicating whether a subsequent frame to be transmitted exists, and a last frame among the at least one frame may be identified based on the more data indicator.

According to an embodiment of the present disclosure, the AP may transmit the last frame including, in a frame header thereof, duration information for receiving a response frame from the second STA, and may terminate reverse direction communication based on the duration information, wherein the last frame is received by the first STA whose address is different from the receiver address of the last frame, thereby indicating whether the AP transmits the last frame and a termination timing of the reverse direction communication based on the duration information, and wherein when the TXOP of the first STA remains after the termination timing of the reverse direction communication, frame transmission by the first STA may be performed through the remaining TXOP of the first STA.

According to an embodiment of the present disclosure, when the AC restriction indicator permits transmission of data having an AC different from the AC of the first STA data in the reverse direction communication, and the TXOP extension grant indicator permits extension of the reverse direction communication period, the AP may determine the reverse direction communication period as the TXOP corresponding to the AC of a second frame transmitted to the second STA when the TXOP corresponding to the AC of the second frame is longer than the TXOP of the first STA, and may determine the reverse direction communication period as the TXOP of the first STA when the TXOP corresponding to the AC of the second frame is shorter than the TXOP of the first STA.

According to an embodiment of the present disclosure, a start time of the TXOP corresponding to the AC of the second frame may be determined as a start time of the TXOP of the first STA or a start time of the reverse direction communication.

According to an embodiment of the present disclosure, the first frame may further include frame segmentation related information, and the AP may transmit at least one frame to the second STA according to a segmented frame length indicated based on the frame segmentation related information, wherein the at least one frame transmitted based on the segmented frame length may be transmitted at a Priority Inter-Frame Space (PIFS) interval that is longer than a Short Inter-Frame Space (SIFS).

According to an embodiment of the present disclosure, when the AP receives a reverse direction communication revoke request frame from the first STA, the reverse direction communication revoke request frame may be received after a SIFS duration from a transmission end time of a second frame among the at least one frame, and upon receiving the reverse direction communication revoke request frame, the AP may transmit a frame indicating suspend of reverse direction communication use to the second STA after a SIFS duration, or may immediately terminate the reverse direction communication.

According to an embodiment of the present disclosure, an acknowledgment policy (ACK policy) of the frame indicating suspend of reverse direction communication use may be set to acknowledgment required, and based on the ACK policy, a response frame to the frame indicating suspend of reverse direction communication use may be received from the second STA after a SIFS duration from receipt of the frame indicating suspend of reverse direction communication use, and upon receiving the response frame, the AP may terminate the reverse direction communication.

According to an embodiment of the present disclosure, when the AP transmits at least one multi-user (MU) frame to a plurality of STAs including the second STA according to a segmented frame length indicated based on the frame segmentation related information, upon receiving the reverse direction communication revoke request frame, the AP may transmit an MU frame indicating suspend of reverse direction communication use to the plurality of STAs including the second STA after a SIFS duration, or may immediately terminate the reverse direction communication, wherein the MU frame may indicate subchannel information on which the plurality of STAs including the second STA are to transmit response frames to the MU frame.

According to an embodiment of the present disclosure, the AP may perform a reverse direction communication membership negotiation procedure with at least one of the first STA or STAs capable of providing reverse direction communication, and may determine a reverse direction communication STA based on the reverse direction communication membership negotiation procedure, wherein the reverse direction communication membership negotiation procedure may determine at least one of: reverse direction operation participation level information indicating whether the reverse direction communication STA mandatorily participates in the reverse direction communication operation; reverse direction operation participation duration information indicating a membership status maintenance duration of the reverse direction communication STA; and reverse direction communication related parameters.

According to an embodiment of the present disclosure, the AP may transmit, to the reverse direction communication STA determined based on the reverse direction communication negotiation procedure, a buffer status report (BSR) including at least one of: total data size information present in a queue of the AP; per-AC data size information; and transmission duration information in the reverse direction communication.

According to an embodiment of the present disclosure, even when no packet exists in a transmission queue after a backoff for the reverse direction communication STA determined based on the reverse direction communication negotiation procedure, an enhanced distributed channel access (EDCA) backoff operation may be performed by the STA for use of reverse direction communication by the AP.

According to an embodiment of the present disclosure, when a multi-user (MU) EDCA parameter configured to cause channel occupancy with a lower probability is set for the reverse direction communication STA determined based on the reverse direction communication negotiation procedure, the MU EDCA parameter may not be applied to the reverse direction communication STA, or a separate EDCA parameter for the reverse direction communication STA may be applied during the period in which the reverse direction communication membership status is maintained based on the reverse direction operation participation duration information.

The technical objectives to be achieved by the present disclosure are not limited to the technical objectives mentioned above, and other technical objectives not mentioned herein will be clearly understood by those skilled in the art to which the present disclosure pertains from the description below. According to the present disclosure, a method for performing reverse direction communication in a WLAN may be provided.

According to the present disclosure, a WLAN terminal may grant a reverse direction communication period to another terminal within a configured transmission interval.

According to the present disclosure, a reverse direction communication period may be determined in a WLAN.

According to the present disclosure, a reverse direction communication period may be reclaimed in a WLAN.

According to the present disclosure, a reverse direction communication membership negotiation procedure may be performed in a WLAN.

According to the present disclosure, a method for selecting reverse direction communication extension, reclaim, and channel access parameters by means of an artificial intelligence-based reverse direction communication scheduling scheme in a WLAN may be provided, whereby channel access delay may be reduced and network efficiency may be increased.

According to the present disclosure, a method may be provided for enabling a WLAN terminal to perform Enhanced Multi-Link Single Radio (EMLSR) operation and to transition to a listen operation, which is an operational state of the EMLSR operation, after the WLAN terminal transmits a frame not requiring a response to a wireless access point.

The effects obtainable from the present disclosure are not limited to the effects mentioned above, and other effects not mentioned herein will be clearly understood by those skilled in the art to which the present disclosure pertains from the description below.

### BRIEF DESCRIPTION OF THE DRAWINGS

FIG. 1 is a diagram illustrating a communication node in a wireless LAN system to which the present disclosure is applied.

FIG. 2 is a diagram illustrating a wireless LAN system to which the present disclosure is applied.

FIG. 3 is a diagram illustrating a machine learning unit to which the present disclosure is applied.

FIG. 4 is a flowchart illustrating a method of performing communication based on a machine learning unit to which the present disclosure is applied.

FIG. 5A and FIG. 5B are diagrams illustrating a reverse direction communication period extension method to which the present disclosure is applied.

FIG. 6A through FIG. 6C are diagrams illustrating a RD interval (reverse direction communication period) reclaim method to which the present disclosure is applied.

FIG. 7A and FIG. 7B are diagrams illustrating a reverse direction transmission inducement scheme of a STA to which the present disclosure is applied.

FIG. 8 is a diagram illustrating a method of applying differentiated channel access parameters based on reverse direction transmission inducement of a STA to which the present disclosure is applied.

FIG. 9 is a diagram illustrating multiple links configured between MLDs to which the present disclosure is applied.

FIG. 10 is a diagram illustrating a frame exchange method during enhanced multi-link single radio operation of a wireless LAN to which the present disclosure is applied.

FIG. 11A and FIG. 11B are diagrams illustrating a frame exchange method during enhanced multi-link single radio operation of a wireless LAN to which the present disclosure is applied.

FIG. 12 is a flowchart illustrating a method of operating an AP performing reverse direction transmission in a wireless LAN to which the present disclosure is applied.

FIG. 13 is a flowchart illustrating a method of operating a STA grant reverse direction transmission in a wireless LAN to which the present disclosure is applied.

### DETAILED DESCRIPTION

The present disclosure is susceptible to various modifications and may have various embodiments, and specific embodiments will be illustrated in the drawings and described in detail. However, this is not intended to limit the present disclosure to specific embodiments, and it should be understood that the present disclosure includes all modifications, equivalents, and substitutes within the spirit and technical scope of the present disclosure.

Terms such as first, second, etc. may be used to describe various components, but said components should not be limited by said terms. Said terms are used only for the purpose of distinguishing one component from another component. In an embodiment, a first component may be designated as a second component, and similarly, a second component may also be designated as a first component, without departing from the scope of the present disclosure. The term “and/or” includes any combination of a plurality of related listed items or any one of a plurality of related listed items.

When a component is referred to as being “connected” or “coupled” to another component, it should be understood that the component may be directly connected or coupled to the other component, but another component may also exist in between. On the other hand, when a component is referred to as being “directly connected” or “directly coupled” to another component, it should be understood that no other component exists in between.

The terms used in the present disclosure are used only to describe specific embodiments and are not intended to limit the present disclosure. Singular expressions include plural expressions unless the context clearly indicates otherwise. In the present disclosure, terms such as “comprise” or “have” are intended to designate the presence of features, numbers, steps, operations, components, parts, or combinations thereof described in the specification, and should be understood as not precluding the possibility of the presence or addition of one or more other features, numbers, steps, operations, components, parts, or combinations thereof.

Unless otherwise defined, all terms used herein, including technical or scientific terms, have the same meaning as commonly understood by those skilled in the art to which the present disclosure pertains. Terms defined in commonly used dictionaries should be interpreted as having meanings consistent with the meanings they have in the context of the relevant art, and unless explicitly defined in the present disclosure, should not be interpreted in an ideal or excessively formal sense.

Hereinafter, preferred embodiments of the present disclosure will be described in greater detail with reference to the accompanying drawings. In describing the present disclosure, the same reference numerals are used for the same components in the drawings to facilitate overall understanding, and duplicate descriptions of the same components are omitted.

In the following, a wireless communication system to which embodiments according to the present disclosure are applied will be described. The wireless communication system to which the embodiments according to the present disclosure are applied is not limited to the content described below, and the embodiments according to the present disclosure may be applied to various wireless communication systems. A wireless communication system may be referred to as a “wireless communication network.”

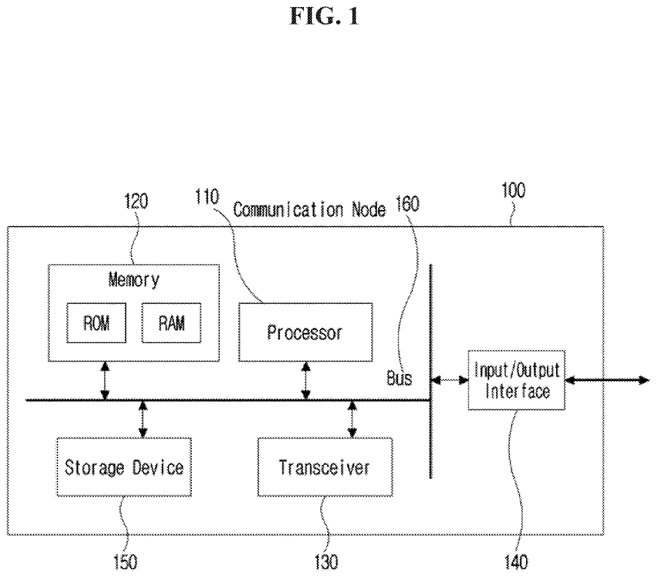

FIG. 1 is a diagram illustrating a communication node in a wireless LAN system to which the present disclosure is applied. Referring to FIG. 1, a communication node (100) may include at least one of a processor (110), a memory (120), a transceiver (130), an input/output interface (140), a storage device (150), and a bus (160). In an embodiment, the communication node (100) may be an access point (AP), a station (STA), an AP multi-link device (MLD), or a non-AP MLD. However, the communication node may not be limited thereto, and may be a node that communicates with other nodes or devices based on the configuration. In an embodiment, an operating channel width supported by an AP may be 20 MHz (megahertz), 80 MHz, 160 MHz, or the like. An operating channel width supported by a station may be 20 MHz, 80 MHz, or the like. However, the present disclosure may not be limited thereto.

The processor (110) within the communication node (100) may control at least one of the memory (120), the transceiver (130), the input/output interface (140), and the storage device (150) as respective components within the communication node. The memory (120) within the communication node (100) may store information regarding instructions and directives executed by the processor (110), and the transceiver (130) may refer to a transceiver, a radio frequency (RF) unit, an RF module, or any other component that performs signal transmission and reception. The input/output interface (140) within the communication node (100) is an interface for input and output that may interoperate with other interfaces, and may further include a separate storage device (150). Each of the components within the communication node (100) may be connected via a bus (160) to communicate with one another.

However, as an embodiment, each of the components included in the communication node (100) may be connected not via a common bus (160), but via individual interfaces or individual buses centered around the processor (110). The processor (110) may be connected to at least one of the memory (120), the transceiver (130), the input/output interface (140), and the storage device (150) via a dedicated interface.

The processor (110) may execute program commands stored in at least one of the memory (120) or the storage device (150). The processor (110) may refer to a central processing unit (CPU), a graphics processing unit (GPU), or a dedicated processor on which methods according to embodiments of the present disclosure are performed. Each of the memory (120) and the storage device (150) may be configured as at least one of a volatile storage medium or a non-volatile storage medium. In an embodiment, the memory (120) may be configured as at least one of a read only memory (ROM) or a random access memory (RAM).

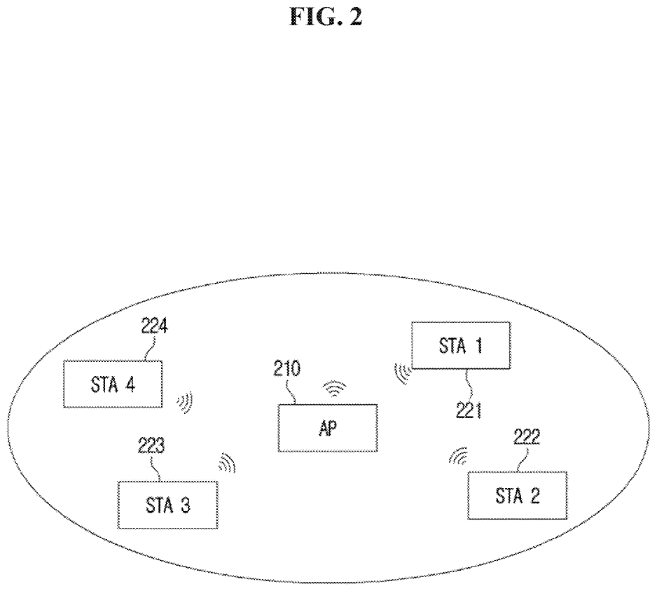

FIG. 2 is a diagram illustrating a wireless LAN system to which the present disclosure is applied. Referring to FIG. 2, a basic service set (BSS) of the wireless LAN system may include one AP (210) and a plurality of STAs (221, 222, 223, 224), and the plurality of STAs (221, 222, 223, 224) may be controlled by the AP (210). However, the wireless LAN system is not limited to a BSS, and an environment consisting only of STAs without a defined service set or AP may also be considered, and the wireless LAN system is not limited to any specific form. Each of the wireless devices within the wireless LAN system may include a medium access control (MAC) layer and a physical (PHY) layer, and communication between the wireless devices may be performed. In the following description, the AP and STA are primarily described for convenience of explanation, but the description may not be limited thereto. In an embodiment, the following may be equally applicable to other communication nodes or devices, and is not limited to any specific form.

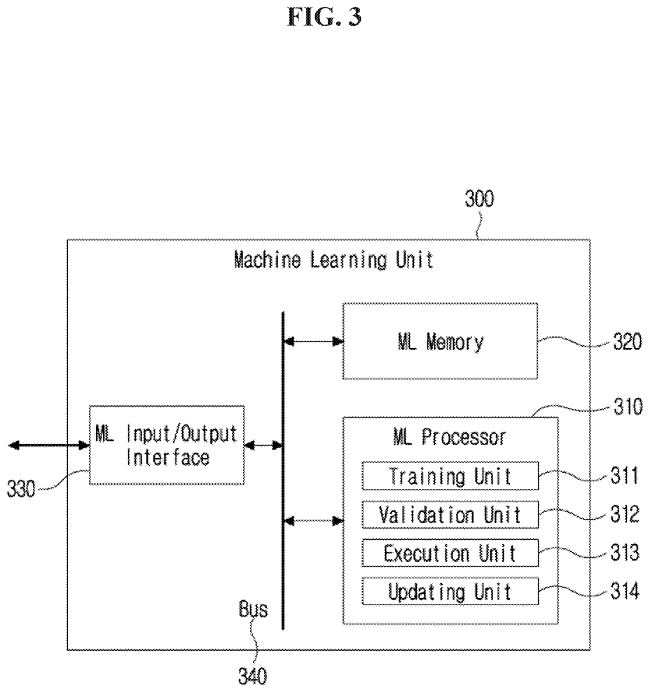

FIG. 3 is a diagram illustrating a machine learning unit to which the present disclosure is applied. Each of the wireless devices within the wireless LAN system may be connected to a machine learning unit (300). However, the present disclosure may not be limited thereto, and it may also be possible for a wireless device that is not connected to the machine learning unit (300) to operate.

In an embodiment, the processor (110) of the communication node (100) of FIG. 1 may be connected to the machine learning unit (300). The machine learning unit (300) may communicate with the processor (110) via the input/output interface (140) of the communication node (100). As another embodiment, the machine learning unit (300) may communicate with the processor (110) via the bus (160) of the communication node (100). As yet another embodiment, the machine learning unit (300) may be connected to and communicate with the processor (110) of the communication node (100) via an individual interface or a dedicated bus. The machine learning unit (300) may be connected to and communicate with the memory (120), the transceiver (130), and the storage device (140) via the input/output interface (140), the bus (160), or a dedicated bus of the communication node (100), but may not be limited to any specific form.

In an embodiment, the machine learning unit (300) may include at least one machine learning (ML) processor (310), an ML memory (320), an ML input/output interface (330), and ML buses (340). The ML processor (310), the ML memory (320), and the ML input/output interface (330) may be connected to and communicate with one another via the ML bus (340). As another embodiment, the ML processor (310) may be connected to and communicate with at least one of the ML memory (320) and the ML input/output interface (330) via a dedicated bus or interface. The ML processor (310) may be a central processing unit, a graphics processing unit, a dedicated processor on which methods according to embodiments of the present disclosure are performed, or a processor combining at least one of a central processing unit and a dedicated processor. The ML processor (310) may include at least one of a training unit (311), a validation unit (312), an execution unit (313), and an updating unit (314). The training unit (311), the validation unit (312), the execution unit (313), and the updating unit (314) may be logical entities implemented in software or hardware processing devices. In an embodiment, the ML processor (310) may perform at least one of training, validation, execution, and updating of a machine learning model. The machine learning model may be in the form of a plurality of matrices or vectors. As a specific embodiment, the machine learning model may include weights, transition matrices, and hyperparameters that implement and train single or multiple combined machine learning algorithms (e.g., deep neural network (DNN), convolutional neural network (CNN), recurrent neural network (RNN), and deep reinforcement learning (DRL) algorithms). The machine learning model may include an input layer, at least one hidden layer, and an output layer to implement a DNN algorithm. Each of the input layer, the hidden layer, and the output layer may include at least one perceptron (e.g., an artificial neuron). A perceptron includes an activation function, input weights, and a bias. A plurality of perceptron may have their inputs and outputs connected to form the input layer, the hidden layer, and the output layer. The machine learning model may include a convolution algorithm and the DNN algorithm to implement a CNN algorithm. The convolution algorithm is an algorithm that applies a kernel matrix to input data in matrix form via convolution, and may be performed at least once on the input data. When the convolution algorithm is performed on the input data, the size of the data may increase through concatenation or decrease through pooling. Input data on which the convolution algorithm has been performed at least once is used as input data for the DNN algorithm. In an embodiment, the machine learning model may include a DNN algorithm and a cell structure to implement an RNN algorithm. The cell structure may be a structure that memorizes previous input data and feeds it back as input, and may be used in at least one perceptron of the DNN algorithm. The machine learning model may include an agent, an environment structure, and a DNN algorithm to implement a DRL algorithm. In the DRL algorithm, the agent may observe the environment and perform an optimal action based thereon. The environment may provide feedback to the agent in the form of a reward based on the action of the agent. Based on the foregoing, the agent may learn a policy for taking optimal actions. The agent may use a DNN algorithm to learn optimal actions.

As another embodiment, the machine learning unit (300) may be designed to additionally implement other machine learning algorithms beyond those already implemented. To this end, the machine learning unit (300) may include additional components for implementing other machine learning algorithms. The ML memory (320) within the machine learning unit (300) may store machine learning models and machine learning algorithms. Implementation of a machine learning algorithm may be performed by the ML processor (310) based on the machine learning model.

As another embodiment, all or part of the functions of the machine learning unit (300) may be integrated into the processor (110) and the memory (120) of the communication node (100). That is, the processor (110) of the communication node (100) may perform some or all of the functions of the ML processor (310), and the memory (120) may perform all or some of the functions of the ML memory (320). When the processor (110) and the memory (120) of the communication node (100) perform all functions of the machine learning unit (300), the machine learning unit (300) may not be connected via the input/output interface (140), and the processor (110) and the memory (120) may operate as the machine learning unit (300).

As another embodiment, the machine learning unit (300) may not be connected via the input/output interface (140) of the communication node (100), but may be connected via the bus (160), or via a dedicated bus or interface centered around the processor (110) of the communication node (100), but the present disclosure may not be limited to such embodiments.

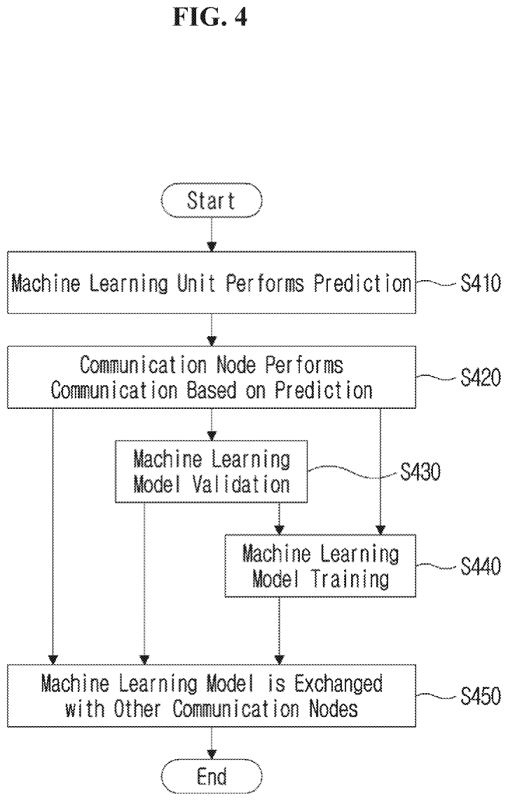

FIG. 4 is a flowchart illustrating a method of performing communication based on a machine learning unit to which the present disclosure is applied. Referring to FIG. 4, the machine learning unit (300) may be connected to the communication node (100) to collect communication data and perform prediction based on a machine learning model (S410). In an embodiment, the prediction may be performed by the execution unit (313) of the machine learning unit (300), but is not limited thereto. Here, the communication data collected by the machine learning unit (300) may include at least one of channel noise status, channel congestion, received signal strength, collision frequency, and other information obtained from the physical layer. In addition, the communication data may include information obtained from the MAC layer, and is not limited to any specific form. The communication data collected by the machine learning unit (300) may be provided as input to the machine learning model as-is. As another embodiment, the communication data collected by the machine learning unit (300) may be processed or pre-processed before being provided as input to the machine learning model. In an embodiment, the prediction result of the machine learning unit (300) may be at least one of physical layer and MAC parameters (e.g., modulation and coding scheme (MCS) parameters, beamforming parameters, enhanced distributed channel access (EDCA) parameters, etc.). As another embodiment, the prediction result of the machine learning unit (300) may be information for packet scheduling, multi-AP operation scheduling, and other scheduling, but is not limited to any specific form. As another embodiment, the communication node (100) may receive all or part of a machine learning model from another communication node. All or part of the machine learning model may be collected by the machine learning unit (300), and is not limited to any specific form. In an embodiment, the communication node (100) may perform communication based on the prediction of the machine learning unit (300) (S420). In addition, the machine learning unit (300) may collect communication data based on the performed communication, and based thereon, machine learning model validation (S430) or machine learning model training (S440) may be performed. Also, In an embodiment, the machine learning model may be exchanged with other communication nodes (S450), and the exchanged machine learning model information may be used for machine learning model validation or machine learning model training. In an embodiment, when machine learning model validation is performed, it may be verified whether the communication operation performed by the prediction of the machine learning unit (300) is appropriate. As a specific embodiment, machine learning model validation may be performed based on at least one of the frame collision frequency, transmission error frequency, and packet transmission delay of the communication node (100), and an operation of determining whether the communication performance of the communication node (100) has improved may be performed.

In addition, In an embodiment, when it is determined that training of the machine learning model is necessary (e.g., when communication performance has not improved, or when the performance of the machine learning model of another communication node (e.g., all or part of the machine learning model) is determined to be superior to the machine learning model of the current communication node (100)), the communication node (100) may perform machine learning model training. As another embodiment, the communication node (100) may exchange the machine learning model with other communication nodes without performing machine learning model validation or machine learning model training. Also, In an embodiment, when it is determined that training of the machine learning model is not necessary, the communication node (100) may exchange the machine learning model with other communication nodes without performing machine learning model training.

Here, the training of the machine learning model may be performed based on at least one of the collected communication data and all or part of the machine learning model of another communication node. The training of the machine learning model may be performed by the training unit (311), and may be performed based on at least one of the collected communication data, the machine learning model of another communication node, and the output of the machine learning model of the communication node (100).

As another embodiment, all or part of the machine learning model of the communication node (100) may be replaced with all or part of the machine learning model of another communication node by the updating unit (314) of the machine learning unit (300). As another embodiment, the machine learning model (e.g., all or part of the machine learning model) of the communication node (100) may be shared with other communication nodes. Alternatively, it may also be possible for the communication node (100) to operate based solely on machine learning model validation and training without exchanging the machine learning model with other communication nodes, and the present disclosure is not limited to any specific form. In an embodiment, in the flowchart of the present disclosure, at least one of reordering of steps, addition or removal of steps, and repetition of specific steps may be performed. That is, the present flowchart is one embodiment illustrating the operation of the machine learning unit (300) of the wireless communication node (100), and the procedures and operations may be variously modified. In an embodiment, it may also be possible for the machine learning model validation step to be performed again after machine learning model training in order to validate the trained machine learning model, and the present disclosure may not be limited to any specific form. Hereinafter, operations related to wireless LAN terminals are described with reference to a station (STA). As used in accordance with IEEE 802.11 terminology, “STA” may refer to both an AP STA operating as an access point (AP) and a non-AP STA operating in connection with an AP. However, for convenience of description, an AP and a non-AP STA are distinguished herein; this distinction is made solely for descriptive purposes, and it will be apparent that operations described with respect to the AP may apply to both AP STAs and non-AP STAs. Likewise, it will be apparent that operations described with respect to a non-AP STA may also apply to both non-AP STAs and AP STAs. Each wireless device within a wireless LAN system may include a medium access control (MAC) layer and a physical (PHY) layer, and communication between wireless devices may be performed. Although the following description focuses on APs and non-AP STAs for convenience of explanation, the present disclosure is not limited thereto. For example, the following may apply equally to other communication nodes or devices and is not limited to any specific form. In addition, an operation considering data that requires a reduction in channel access delay is described below. Here, the data requiring a reduced channel access delay may be referred to as low-latency data, low-latency traffic, or other terms, and may not be limited to a specific form. As an embodiment, indication operations or other operations performed below may be interpreted as indication operations or other operations for low latency. For convenience of explanation, the following description uses the terms “data” or “traffic,” but as described above, these may be data requiring a reduction in channel access delay, low-latency data, or low-latency traffic, and are not limited to a specific form.

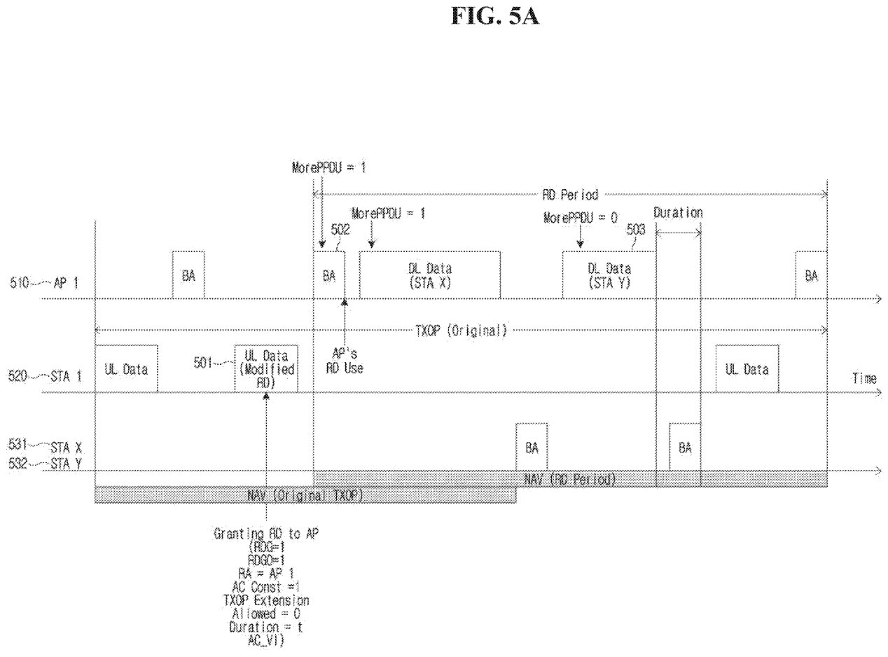

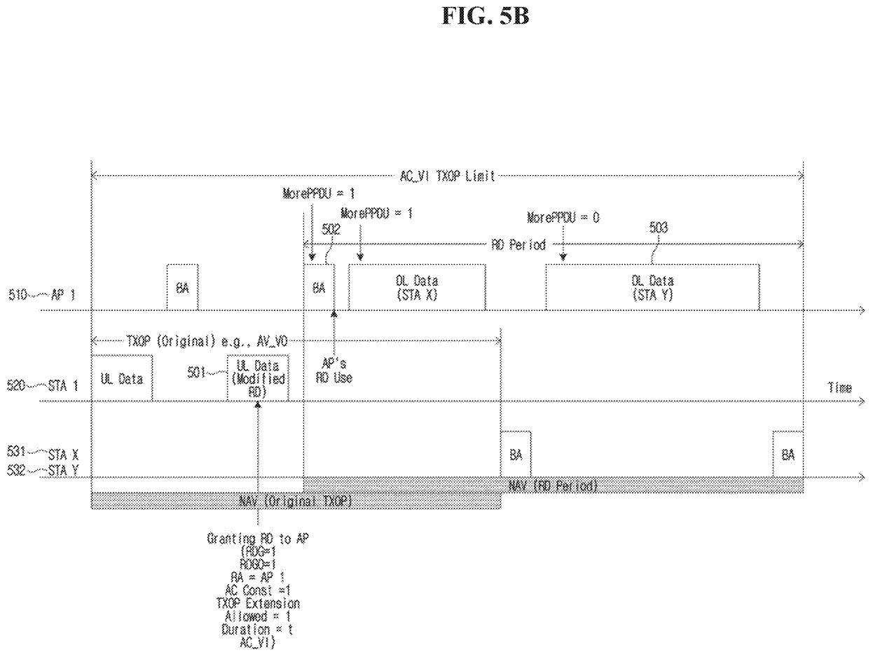

FIG. 5A and FIG. 5B are diagrams illustrating a reverse direction communication period extension method to which the present disclosure is applied. In an embodiment, FIG. 5A and FIG. 5B may illustrate a method of extending a reverse direction communication period in an environment where an AP (510), STA 1 (520), STA X (531), and STA Y (532) perform communication. However, this is for convenience of explanation only, and the same may be equally applicable to operations based on other devices or nodes. In the following description, the case where the AP (510), STA 1 (520), STA X (531), and STA Y (532) perform communication is primarily described for convenience of explanation.

Referring to FIG. 5A, STA 1 (520) may perform an Enhanced Distributed Channel Access (EDCA) backoff, and may transmit a frame upon successful backoff. That is, STA 1 (520) may occupy a channel based on the EDCA backoff procedure and perform frame transmission on the occupied channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value and then decrement the backoff counter value. When the backoff counter value reaches zero based on the decrement of the backoff counter value, the EDCAF may perform frame transmission at the slot boundary of the slot at which the backoff counter value reaches zero. Specifically, when the EDCAF of STA 1 (520) performs frame transmission based on the foregoing, an EDCA transmission opportunity (TXOP) may be granted to the EDCAF of STA 1 (520). That is, STA 1 (520) may be allocated a TXOP, and STA 1 (520) may initiate communication with other STAs within a configured transmission opportunity (TXOP) duration set within a predetermined TXOP limit to perform data transmission and reception. In an embodiment, the TXOP limit may differ for each AC, and may be 2.258 ms for AC_BK, 2.528 ms for AC_BE, 4.096 ms for AC_VI, and 2.080 ms for AC_VO. Here, the AP may transmit different TXOP limit values based on broadcast, and STAs that receive the TXOP limit values may use the received values. As another embodiment, the TXOP limit value may be determined by individual configuration of the AP and the STA, but is not limited to such embodiments.

Referring to FIG. 5A, when STA 1 (520) successfully occupies the channel, it may set the Duration parameter in the header of the data to be transmitted (e.g., UL Data) to the TXOP duration. In an embodiment, in FIG. 5A, the TXOP duration may be set to TXOP (Original). Here, STA 1 (520) may grant another STA permission to use the TXOP within the configured TXOP duration. The operation of granting permission for another STA to use the TXOP configured by a STA may be a reverse direction transmission operation or reverse direction communication. In an embodiment, the STA that initiates reverse direction communication may be an RD initiator, and the STA that is allocated the reverse direction communication may be an RD responder, but the present disclosure may not be limited to such designations.

Referring to FIG. 5A, STA 1 (520) may grant reverse direction communication within the configured TXOP. When STA 1 (520) grants reverse direction communication within the configured TXOP, STA 1 (520) may transmit a frame (501) including a reverse direction grant (RDG) indicator, an access category (AC) constraint indicator, and the AC of the data to be transmitted in the header of the frame (501) transmitted to grant reverse direction communication. That is, the frame (501) transmitted by STA 1 (520) may be a frame that shares the TXOP with the AP. In an embodiment, the RDG indicator of STA 1 (520) may indicate whether a STA (e.g., AP 1) receiving data within the TXOP duration (e.g., TXOP (Original)) is permitted to transmit data in the reverse direction. As a specific embodiment, when the RDG is set to 1, a STA (e.g., AP 1) receiving data within the TXOP duration may transmit reverse direction data to another STA. On the other hand, when the RDG is set to 0, a STA (e.g., AP 1) receiving data within the TXOP duration may not transmit reverse direction data to another STA.

When the RDG is set to 1, the RD initiator may additionally include a reverse direction grant others (RDGO) indicator in the header for transmission. The RDGO indicator may indicate the target STA to which reverse direction data may be transmitted. When the RDGO is set to 0, the RD responder may perform reverse direction data transmission only to the RD initiator. On the other hand, when the RDGO is set to 1, the RD responder may also perform data transmission to STAs other than the RD initiator. In an embodiment, when the RDGO indicator is not included in the header, the RD responder may perform reverse direction data transmission only to the RD initiator. That is, when the RDGO indicator is not included in the header, the RD responder may operate in the same manner as when the RDGO is set to 0.

The AC constraint indicator may indicate whether a STA transmitting data via reverse direction communication is permitted to transmit only data of the same AC type as the data transmitted with the RDG set. When the AC constraint indicator is set to 1, a STA transmitting data via reverse direction communication may transmit only AC data of the same type as the data transmitted with the RDG set. On the other hand, when the AC constraint indicator is set to 0, a STA transmitting data via reverse direction communication may transmit AC data of a different type from the data transmitted with the RDG set. In addition, when the AC constraint indicator is set to 0, the header may further include a TXOP extension allowed indicator for transmission. The TXOP extension allowed indicator may indicate whether extension of the TXOP limit is permitted when transmitting AC data of a different type. When the TXOP extension allowed indicator is set to 0, a STA transmitting AC data of a different type from the data transmitted with the RDG set may perform reverse direction transmission only within the initially configured TXOP (TXOP (Original)). On the other hand, when the TXOP extension allowed indicator is set to 1, a STA transmitting AC data of a different type from the data transmitted with the RDG set may perform reverse direction transmission using a TXOP limit longer than the initially configured TXOP (TXOP (Original)).

In an embodiment, the RDG indicator, the RDGO indicator, the AC constraint indicator, and the TXOP extension allowed indicator may each be a 1-bit value. The RDG indicator, the RDGO indicator, the AC constraint indicator, and the TXOP extension allowed indicator may be included in a subfield of the A-control field in the header whose control ID (Control ID) is CAS (command and status). That is, the RDG indicator, the RDGO indicator, the AC constraint indicator, and the TXOP extension allowed indicator may be included in the CAS A-control field for transmission.

In addition, In an embodiment, the RDG indicator may be used as a more PPDU (physical protocol data unit) indicator based on the communication procedure. A STA performing reverse direction communication as indicated by the RDG may set the more PPDU indicator to 1 to request allocation of an additional reverse direction grant (RDG) if there is additional data to be transmitted after the currently transmitted data. In addition, for the terminal that initially granted the RDG, the RDG indicator of the last transmitted data is interpreted as a more PPDU indicator, and when set to 0, may indicate that there is no additional data to be transmitted.

Referring to FIG. 5A, STA 1 (520) may successfully contend for the channel (i.e., successfully complete the channel access procedure) and transmit data. Here, STA 1 (520) may configure reverse direction communication for AP 1 (510) within the configured TXOP. When STA 1 (520) grants reverse direction communication to AP 1 (510), STA 1 (520) may set the RDG in the data frame (501) transmitted prior to the point at which reverse direction communication is granted, and transmit it to AP 1 (510).

In addition, In an embodiment, STA 1 (520) may set the AC constraint indicator to 1 to permit transmission of a different type of AC. In an embodiment, in FIG. 5A, STA 1 (520) may set the TXOP extension allowed indicator to 0 so as to permit transmission of a different type of AC but require that such transmission be performed within the existing TXOP limit (TXOP (Original)). That is, STA 1 (520) may set the TXOP extension allowed indicator to 0 in order to permit transmission of a different type of AC while not permitting modification of the TXOP limit. Since the TXOP extension allowed indicator is set to 0, AP 1 (510) may perform reverse direction communication only within the TXOP configured by STA 1 (TXOP (Original)).

In an embodiment, even when the TXOP limit of the AC that AP 1 (510) intends to transmit via reverse direction communication is shorter than the TXOP configured by STA 1 (520), the reverse direction communication period may not be reduced by the TXOP limit of the new AC, and may be set within the TXOP granted by STA 1 (520).

When AP 1 (510) has a frame (e.g., a data frame) to transmit via reverse direction communication, AP 1 (510) may set the more PPDU indicator of the block acknowledgment (BA) frame (502) transmitted as a response frame to the data frame (501) of STA 1 (520) to 1 for transmission. Through this, AP 1 (510) may indicate to STA 1 (520) the initiation of reverse direction communication. In an embodiment, STA 1 (520) may permit AP 1 (510) to transmit frames to STAs other than STA 1 (520) during the reverse direction communication period. That is, STA 1 (520) may transmit the data frame (501) to AP 1 (510) with both the RDG indicator and the RDGO indicator set to 1, and based thereon, AP 1 (510) may perform frame transmission to another STA (e.g., STA X or STA Y). AP 1 (510) may transmit frames to other STAs (STA X or STA Y) within the reverse direction communication period and receive response frames thereto. When AP 1 (510) has no more frames to transmit in the reverse direction communication period, it may set the more PPDU indicator of the last frame (503) to be transmitted to 0 for transmission. Here, the duration set in the header of the last frame transmitted by AP 1 (510) may be set to cover the time required to receive the BA for the last frame (503). STA 1 (520) may receive and decode all data transmitted by AP 1 (510) during the reverse direction communication period even when the receiver address (RA) of the data is not STA 1 (520). Through this, STA 1 (520) may check the more PPDU parameter (more PPDU indicator) of the data transmitted by AP 1 (510), and upon confirming that the more PPDU indicator is set to 0, may recognize that AP 1 (510) is terminating the reverse direction communication period. More specifically, STA 1 (520) may recognize that AP 1 (510) terminates the reverse direction communication after the duration indicated in the frame header of the last frame (503) in which the more PPDU transmitted by AP 1 (510) is set to 0. When the initially configured TXOP remains after the duration, STA 1 (520) may use the TXOP to transmit frames to AP 1 (510) or other STAs. In an embodiment, when STA 1 (520) has no frames to transmit to AP 1 (510) or other STAs, STA 1 (520) may transmit a contention free-END (CF-END) frame to terminate the TXOP.

Referring to FIG. 5B, STA 1 (520) may successfully contend for the channel (i.e., successfully complete the channel access procedure) and transmit data. Here, STA 1 (520) may configure reverse direction communication for AP 1 (510) within the configured TXOP. When STA 1 (520) grants reverse direction communication to AP 1 (510), STA 1 (520) may set the RDG in the frame (501) transmitted prior to the point at which reverse direction communication is granted, and transmit it to AP 1 (510). That is, the frame (501) transmitted by STA 1 (520) may be a frame that shares the TXOP with the AP.

In addition, In an embodiment, STA 1 (520) may set the AC constraint indicator to 1 to permit transmission of a different type of AC. In an embodiment, unlike FIG. 5A, in FIG. 5B, STA 1 (520) may set the TXOP extension allowed indicator to 1 to permit transmission of a different type of AC as well as to permit modification of the changed TXOP limit for transmission of a different type of AC. That is, STA 1 (520) may permit both transmission of a different type of AC and modification of the TXOP limit, and to this end, may set the TXOP extension allowed indicator to 1. Since the TXOP extension allowed indicator is set to 1, AP 1 (510) may apply a TXOP limit different from the TXOP configured by STA 1 (520) (TXOP (Original)).

Here, the modification of the TXOP limit may be determined using an initially negotiated TXOP value or a pre-determined TXOP value. As another embodiment, the modification of the TXOP limit may be determined in accordance with the longest TXOP limit among the ACs of the data to be transmitted in the reverse direction communication period. When using the initially negotiated TXOP value or a pre-determined TXOP value, the interval available for reverse direction communication may be calculated by applying the negotiated TXOP value or the pre-determined TXOP value from the point at which the TXOP was initially configured. Here, when the newly applied interval is shorter than the reverse direction communication period allocated by STA 1 (520), the interval used for reverse direction communication may be the reverse direction communication period allocated by STA 1 for reverse direction communication. As another embodiment, the negotiated TXOP value or the pre-determined TXOP value may be applied from the point at which the reverse direction communication period was allocated, and reverse direction communication may be performed based thereon.

Referring to FIG. 5B, the TXOP extension allowed indicator may be set to 1, and accordingly, AP 1 (510) may modify the TXOP limit. When the TXOP limit corresponding to the AC of the frame that AP 1 (510) intends to transmit is longer than the TXOP configured by STA 1 (520) (TXOP (Original), e.g., AC_VO TXOP), AP 1 (510) may perform reverse direction communication within the corresponding interval using the TXOP limit corresponding to the AC of the frame to be transmitted that has a longer value (e.g., AC_VI TXOP). Here, the application of the new TXOP may be used by calculating the new TXOP limit interval from the start time of the TXOP initially configured by STA 1 (520).

As another embodiment, the modified TXOP limit may be applied from the point at which reverse direction communication is granted. That is, the new TXOP may start from the point at which reverse direction communication is granted, and the interval to which the new TXOP limit is applied may be determined and used from that point.

As another embodiment, when the TXOP limit of the AC that AP 1 (510) intends to transmit via reverse direction communication is shorter than the TXOP configured by STA 1 (520), the reverse direction communication period may not be reduced by the TXOP limit of the new AC, and may be used within the TXOP granted by STA 1 (520). As another embodiment, even when the TXOP limit of the AC that AP 1 (510) intends to transmit via reverse direction communication is shorter than the TXOP configured by STA 1 (520), if the new TXOP starts from the point at which reverse direction communication is granted, the new TXOP limit may be applied from the point at which reverse direction communication is granted to determine the interval (i.e., the new TXOP of AP 1 (510) may newly start from the point at which reverse direction communication is granted), but the present disclosure is not limited to such embodiments.

When AP 1 (510) has a frame (e.g., a data frame) to transmit via reverse direction communication, AP 1 (510) may set the more PPDU indicator of the block acknowledgment (BA) frame (502) transmitted as a response frame to the data frame (501) of STA 1 (520) to 1 for transmission. Through this, AP 1 (510) may indicate to STA 1 (520) the initiation of reverse direction communication. In an embodiment, STA 1 (520) may permit AP 1 (510) to transmit frames to STAs other than STA 1 (520) during the reverse direction communication period. That is, STA 1 (520) may transmit the data frame (501) to AP 1 (510) with both the RDG indicator and the RDGO indicator set to 1, and based thereon, AP 1 (510) may perform frame transmission to another STA. AP 1 (510) may transmit frames to other STAs (STA X (531) or STA Y (532)) within the reverse direction communication period and receive response frames thereto. When AP 1 (510) has no more frames to transmit in the reverse direction communication period, it may set the more PPDU indicator of the last frame (503) to be transmitted to 0 for transmission.

Here, the duration set in the header of the last frame transmitted by AP 1 (510) may be set to cover the time required to receive the BA for the last frame (503). STA 1 (520) may receive and decode all data transmitted by AP 1 (510) during the reverse direction communication period even when the receiver address (RA) of the data transmitted by AP 1 (510) is not STA 1 (520). Through this, STA 1 (520) may check the more PPDU parameter of the data transmitted by AP 1 (510), and upon confirming that the more PPDU indicator is set to 0, may recognize that AP 1 (510) is terminating the reverse direction communication period. More specifically, STA 1 (520) may recognize that AP 1 (510) terminates the reverse direction communication after the duration indicated in the frame header of the last frame (503) in which the more PPDU transmitted by AP 1 (510) is set to 0. When the initially configured TXOP remains after the duration, STA 1 (520) may use the remaining TXOP to transmit frames to AP 1 (510) or other STAs. In an embodiment, when STA 1 (520) has no frames to transmit to AP 1 (510) or other STAs, STA 1 (520) may transmit a contention free-END (CF-END) frame to terminate the TXOP.

When AP 1 (510) selects target STAs (e.g., STA 1, STA X, STA Y) to which frames are to be transmitted in the RD interval and extends the TXOP, a machine learning unit and machine learning algorithm based on FIG. 3 and FIG. 4 may be used. As a specific embodiment, AP 1 (510) may always receive buffer status reports (BSRs) from STAs and may check queue information for data to be transmitted to the STAs. That is, AP 1 (510) may be aware of information regarding traffic to be received from or transmitted to the STAs. AP 1 (510) may use the traffic information as input to a machine learning algorithm (e.g., deep reinforcement learning (DRL)). That is, AP 1 may utilize the traffic information as a state obtained from the environment of the DRL algorithm. The operations of AP 1 (510) of “scheduling traffic to STAs” and “extending the TXOP for reverse direction communication” may be regarded as actions of the DRL algorithm. In addition, transmitting more downlink frames to a specific STA or extending the TXOP to perform reverse direction communication may constitute actions of AP 1 (510).

AP 1 (510) may schedule frames to the STAs and subsequently collect traffic information from each of the STAs and AP 1. The collected traffic information of AP 1 may be regarded as a reward of the DRL algorithm, and AP 1 (510) may train the agent in a direction that maximizes the reward. As a specific embodiment, appropriate scheduling of traffic may constitute the reward, and based thereon, the agent (i.e., the agent of the DRL algorithm) may perform learning. Through the foregoing, AP 1 (510) may perform optimal scheduling operations in the RD interval (e.g., selection of the optimal STA to be scheduled and extension of the reverse direction communication period).

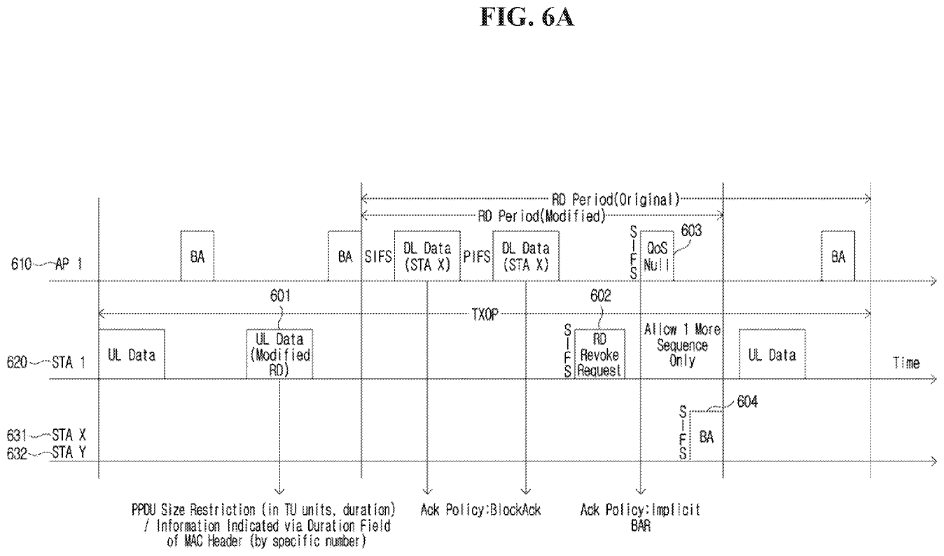

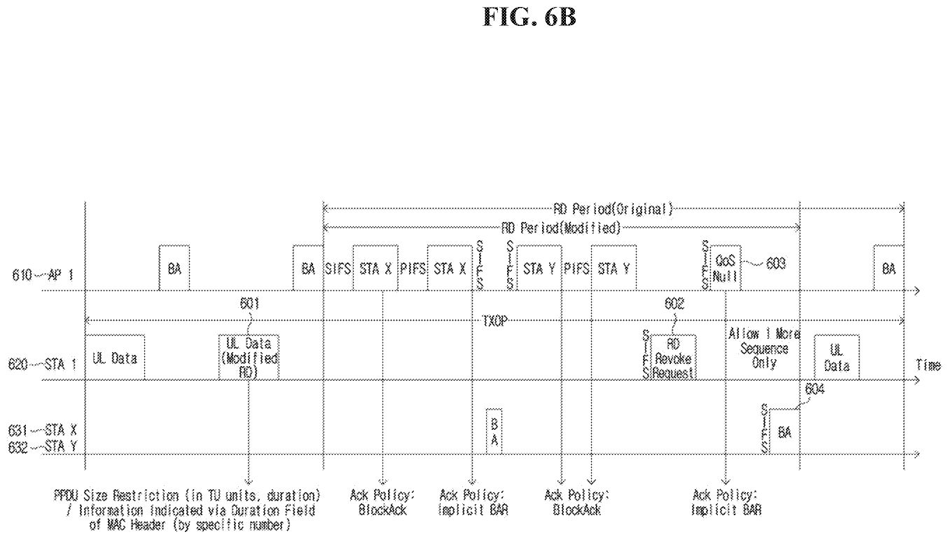

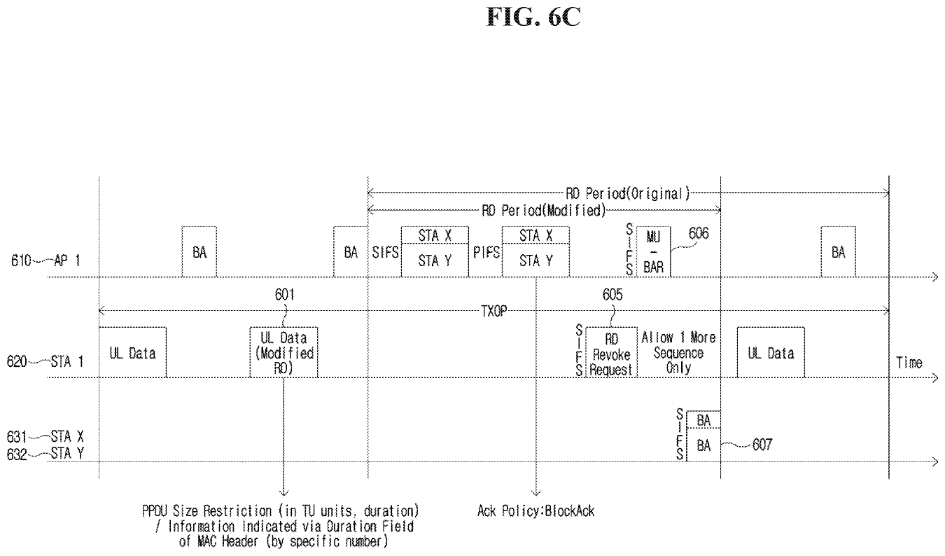

FIG. 6A through FIG. 6C are diagrams illustrating an RD interval revoke method to which the present disclosure is applied. Referring to FIG. 6A through FIG. 6C, the environment may be one in which AP 1 (610), STA 1 (620), STA X (630), and STA Y (640) operate in a wireless LAN network. Here, STA X (630) and STA Y (640) may be STAs different from STA 1 (620). However, FIG. 6A through FIG. 6C are merely one embodiment for convenience of explanation and may not be limited to the described situation.

STA 1 (620) may perform an Enhanced Distributed Channel Access (EDCA) backoff, and may transmit a frame upon successful backoff. That is, STA 1 (620) may occupy a channel based on the EDCA backoff procedure and perform frame transmission on the occupied channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value and then decrement the backoff counter value. When the backoff counter value reaches zero based on the decrement of the backoff counter value, the EDCAF may perform frame transmission at the slot boundary of the slot at which the backoff counter value reaches zero. When the EDCAF of STA 1 (620) determines frame transmission, an EDCA transmission opportunity (TXOP) may be granted to the EDCAF of STA 1 (620). That is, STA 1 (620) may be allocated a TXOP, and STA 1 (620) may initiate communication with other STAs within a transmission opportunity (TXOP) duration set within a predetermined TXOP limit to perform data transmission and reception.

STA 1 (620) may transmit an uplink data frame (601) to AP 1 (610) in the first frame of the TXOP. AP 1 (610) may respond to STA 1 (620) with a block acknowledgment (BA) frame. STA 1 (620) may then transmit another uplink data frame (601) to AP 1 (610).

The uplink data frame (601) transmitted by STA 1 (620) may include at least one of an indicator indicating RD (e.g., RDG), an access category (AC) constraint indicator, and an RDG others (RDGO) indicator indicating whether RD is permitted to another STA. In an embodiment, the indicator indicating RD may be included in the HT Control field included in the MAC header of MPDUs (MAC protocol data units) included in the uplink data frame (601) transmitted by STA 1 (620). The information included in the HT Control field may be A-control information, which may be command and status (CAS) control. The CAS control may include an RDG/more PPDU bit. When STA 1 (620) indicates RD to AP 1 (610), the RDG/more PPDU bit may be set to 1. As another embodiment, the indicator indicating RD from STA 1 (620) to AP 1 (610) may be transmitted in another form. In an embodiment, the indicator indicating RD may be indicated by a single or a plurality of indicators, and is not limited to any specific form. In addition, the indicator by which STA 1 (620) indicates RD to AP 1 (610) may further include frame segmentation related information (e.g., information for PPDU (PHY layer protocol data unit) segmentation). In an embodiment, the frame segmentation related information may be indicated in units of time. As a specific embodiment, the frame segmentation related information may be indicated in units of time unit (TU), where 1 TU equals 1024 μs. The frame segmentation related information indicated in TU units may be a real number, but is not limited to such embodiments.

As another embodiment, the frame related information may be indicated in units of frame duration (e.g., in units of μs, which is the frame duration unit of the MAC layer). As another embodiment, the frame segmentation related information may be indicated using the Duration/ID field of the MAC header included in the MPDU of the uplink data frame (602) that includes the indicator by which STA 1 (620) indicates RD to AP 1 (610). In an embodiment, when the information originally included in the Duration/ID field is 3600 μs and the aSlotTime is 9 μs (3600 mod 9=0), the corresponding value may be 0. Here, when the Duration/ID field value is 3599 μs, which is 1 μs less than the original Duration/ID field value, the corresponding value may be 8 (3599 mod 9=8). Here, STA 1 (620) may indicate the frame segmentation related information by excluding a portion of the time from the information that should be included in the original Duration/ID field. That is, AP 1 (610) may obtain values of 1 through 8 as frame segmentation related information from the Duration/ID field of 3592 through 3599 μs based on the remainder of 9 obtained through the modulo operation. STA 1 (620) may indicate values of 1 through 8 as the frame segmentation related information, and the frame segmentation length information may be information pre-configured between STA 1 (620) and AP 1 (610) based on the values of 1 through 8. However, the frame segmentation related information may be indicated by methods other than those described above, and is not limited to any specific form. Here, STA 1 (620) may indicate that the frame transmission interval of AP 1 (610) is to be a priority inter-frame space (PIFS) interval. The PIFS interval may be a longer duration than the short inter-frame space (SIFS) interval (e.g., longer by aSlotTime).

Referring to FIG. 6A, AP 1 (610) may transmit a BA frame to STA 1 (620). In addition, the BA frame transmitted by AP 1 (610) to STA 1 (620) may include an indicator accepting or rejecting the RD indicated by STA 1. In an embodiment, the indicator accepting or rejecting the RD may be the more PPDU parameter (indicator). Specifically, when the more PPDU indicator is set to 1, the RD may be accepted, and when the more PPDU indicator is set to 0, the RD may be rejected. When AP 1 (610) accepts the RD indicated by STA 1 (620), AP 1 (610) may be granted an RD interval within the TXOP of STA 1 (620). The RD interval may be the reverse direction communication period as described above. Here, when the RDGO indicator in the uplink frame (601) transmitted by STA 1 (620) is set to 1, AP 1 (610) may perform frame transmission to STAs other than STA 1 (620) (STA X or STA Y) within the RD interval. That is, AP 1 (610) may transmit at least one frame to at least one STA (e.g., STA 1, STA X, STA Y) within the RD interval. In addition, AP 1 (610) may segment a frame (e.g., PPDU) according to the frame segmentation related information within the RD interval. In an embodiment, when AP 1 (610) is required to segment PPDUs in units of 500 μs, the maximum length of frames transmitted by AP 1 (610) to the STAs may be 500 μs. In addition, when STA 1 (620) has indicated the frame transmission interval of AP 1 as PIFS, the frames transmitted by AP 1 (610) may be transmitted separated by PIFS intervals. When the frame transmission interval of AP 1 (610) is set to a PIFS interval, STA 1 (620) may occupy the medium within the RD interval at a SIFS duration, which is shorter than PIFS, and an operation for revoking the TXOP may be possible.

As a specific embodiment, referring to FIG. 6A, the RD interval of AP 1 (610) may be equal to the end time of the TXOP of STA 1 (620). That is, AP 1 (610) may use the medium until the TXOP of STA 1 (620) expires. Here, AP 1 (610) may transmit a frame to STA X (631). AP 1 (610) may segment the frame to be transmitted to STA X (631) into three frames based on the frame segmentation related information indicated by STA 1 (620), and each of the segmented frames may be transmitted at PIFS intervals. When AP 1 (610) continues transmission without terminating the RD interval, the more PPDU in the frame header of the frame transmitted by AP 1 (610) may be set to 1. On the other hand, when AP 1 (610) transmits the last frame of the segmented frames, the more PPDU in the frame header may be set to 0. Here, the acknowledgment policy (ACK policy) of the segmented frames may be set to block acknowledgment (BlockAck). When STA X (631) receives a frame whose acknowledgment policy is set to BlockAck, STA X (631) may record the reception status of the frame in the BlockAck scoreboard and may not respond to the frame.

In an embodiment, after AP 1 (610) transmits two frames to STA X (631), STA 1 (620) may transmit an RD revoke request frame (602) to AP 1 (610) after a SIFS duration from the transmission end time of the second frame of AP 1 (610). The RD revoke request frame (602) may be a frame transmitted by STA 1 (620) to terminate the RD interval and use the remaining TXOP. The RD revoke request frame (602) may be any one of a quality of service (QoS) frame requesting RD revoke (e.g., a QoS Null frame indicated with RDG=0), an action frame, and other frames. When AP 1 (610) receives the RD revoke request frame (602) from STA 1 (620), AP 1 (610) may perform any one of the operations in Table 1 below.

TABLE 1
1. Prior to terminating RD interval use, AP 1 transmits a QoS Null
frame to STA X, with the ACK policy of the QoS Null
frame set to implicit BAR.
2. AP 1 immediately terminates RD interval use.

Specifically, when AP 1 (610) performs the first operation in Table 1, AP 1 (610) may transmit a QoS Null frame to STA X (631) after a SIFS duration from receipt of the RD revoke request frame (602). The transmitted QoS Null frame (603) may have the more PPDU indicator set to 0, and may indicate that the RD is terminated. STA X (631) may receive a frame from AP 1 (610) whose acknowledgment policy (ACK policy) is set to implicit BAR, and accordingly may transmit a BA frame to AP 1 (610) after a SIFS duration. As another embodiment, AP 1 (610) may transmit a block acknowledgment request (BAR) frame to STA X (631), and STA X (631) may transmit a BA frame (604) to AP 1 (610) based on the BAR frame. The BAR frame may be combined with the QoS Null frame (603) in the form of an A-MPDU, and the more PPDU indicator of the QoS Null frame (603) combined with the BAR frame may be set to 0. Since AP 1 (610) has received the RD revoke request frame (602), upon receiving the BA frame (604), AP 1 (610) may terminate the RD interval. Thereafter, the remaining TXOP interval may be used by STA 1 (620).

As another embodiment, when AP 1 (610) performs the second operation in Table 1, AP 1 (610) may no longer transmit frames. STA 1 (620) may detect that the medium is in an idle state for a PIFS duration, and based thereon, STA 1 (620) may use the remaining TXOP interval. Within the remaining TXOP interval, STA 1 (620) may further transmit frames (e.g., UL data frames). Through the foregoing, STA 1 (620) may obtain an opportunity to use the TXOP again even after granting the RD interval to AP 1 (610), and efficiency may be increased in situations where STA 1 (620) needs to additionally transmit frames.

In addition, In an embodiment, when AP 1 (610) determines target STAs (e.g., STA 1, STA X, STA Y) to which frames are to be transmitted in the RD interval, the machine learning unit and machine learning algorithm of FIG. 3 and FIG. 4 described above may be used. As a specific embodiment, AP 1 (610) may always receive buffer status reports (BSRs) from STAs and may check queue information for data to be transmitted to the STAs. That is, AP 1 (610) may be aware of information regarding traffic to be received from or transmitted to the STAs. AP 1 (610) may use the traffic information as input to a machine learning algorithm (e.g., deep reinforcement learning (DRL)). That is, AP 1 (610) may utilize the traffic information as a state obtained from the environment of the DRL algorithm. The operation of AP 1 (610) of “scheduling traffic to STAs” may be regarded as an action of the DRL algorithm. In addition, transmitting more downlink frames to a specific STA may constitute an action of AP 1 (510).

AP 1 (610) may schedule frames to the STAs and subsequently collect traffic information from each of the STAs and AP 1. The collected traffic information of AP 1 may be regarded as a reward of the DRL algorithm, and AP 1 (610) may train the agent in a direction that maximizes the reward. As a specific embodiment, appropriate scheduling of traffic may constitute the reward, and based thereon, the agent (i.e., the agent of the DRL algorithm) may perform learning. Through the foregoing, AP 1 (610) may perform optimal scheduling operations in the RD interval (e.g., selection of the optimal STA to be scheduled).

FIG. 6B is a diagram illustrating an RD interval revoke method to which the present disclosure is applied. Referring to FIG. 6B, the environment may be one in which AP 1 (610), STA 1 (620), STA X (631), and STA Y (632) operate in a wireless LAN network. Here, STA X (631) and STA Y (632) may be STAs different from STA 1 (620). In addition, FIG. 6B is merely one embodiment for convenience of explanation and may not be limited to the described situation.

STA 1 (620) may perform an Enhanced Distributed Channel Access (EDCA) backoff, and may transmit a frame upon successful backoff. That is, STA 1 (620) may occupy a channel based on the EDCA backoff procedure and perform frame transmission on the occupied channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value and then decrement the backoff counter value. When the backoff counter value reaches zero based on the decrement of the backoff counter value, the EDCAF may perform frame transmission at the slot boundary of the slot at which the backoff counter value reaches zero. When the EDCAF of STA 1 (620) determines frame transmission, an EDCA transmission opportunity (TXOP) may be granted to the EDCAF of STA 1 (620). That is, STA 1 (620) may be allocated a TXOP, and STA 1 (620) may initiate communication with other STAs within a transmission opportunity (TXOP) duration set within a predetermined TXOP limit to perform data transmission and reception. STA 1 (620) may transmit an uplink data frame to AP 1 (610) in the first frame of the TXOP. AP 1 (610) may respond to STA 1 (620) with a block acknowledgment (BA) frame. STA 1 (620) may then transmit another uplink data frame (601) to AP 1 (610).

The uplink data frame (602) transmitted by STA 1 (620) may include at least one of an indicator indicating RD (e.g., RDG), an access category (AC) constraint indicator, and an RDG others (RDGO) indicator indicating whether RD is permitted to another STA. In an embodiment, the indicator indicating RD may be included in the HT Control field included in the MAC header of MPDUs (MAC protocol data units) included in the uplink data frame (601) transmitted by STA 1 (620). The information included in the HT Control field may be A-control information, which may be command and status (CAS) control. The CAS control may include an RDG/more PPDU bit. When STA 1 (620) indicates RD to AP 1 (610), the RDG/more PPDU bit may be set to 1. As another embodiment, the form of the indicator by which STA 1 (620) indicates RD to AP 1 (610) may vary. In an embodiment, the indicator indicating RD may be indicated by a single or a plurality of indicators, and is not limited to any specific form. In addition, In an embodiment, the indicator by which STA 1 (620) indicates RD to AP 1 (610) may further include frame segmentation related information (e.g., information for PPDU (PHY layer protocol data unit) segmentation). The frame segmentation related information may be indicated in units of time. As a specific embodiment, the frame segmentation related information may be indicated in units of time unit (TU), where 1 TU equals 1024 μs. The frame segmentation related information indicated in TU units may be a real number, but is not limited to such embodiments.

As another embodiment, the frame related information may be indicated in units of frame duration (e.g., in units of μs, which is the frame duration unit of the MAC layer). As another embodiment, the frame segmentation related information may be indicated using the Duration/ID field of the MAC header included in the MPDU of the uplink data frame (601) that includes the indicator by which STA 1 (620) indicates RD to AP 1 (610). In an embodiment, when the information originally included in the Duration/ID field is 3600 μs and the aSlotTime is 9 μs (3600 mod 9=0), the corresponding value may be 0. Here, when the Duration/ID field value is 3599 μs, which is 1 μs less than the original Duration/ID field value, the corresponding value may be 8 (3599 mod 9=8). Here, STA 1 (620) may indicate the frame segmentation related information by excluding a portion of the time from the information that should be included in the original Duration/ID field. That is, AP 1 (610) may obtain values of 1 through 8 as frame segmentation related information from the Duration/ID field of 3592 through 3599 μs based on the remainder of 9 obtained through the modulo operation. When STA 1 (620) indicates values of 1 through 8, the frame segmentation length information may be information pre-configured between STA 1 (620) and AP 1 (610) according to the values of 1 through 8.

However, the frame segmentation related information may be indicated by methods other than those described above, and is not limited to any specific form. Here, STA 1 (620) may indicate that the frame transmission interval of AP 1 (610) is to be a PIFS interval. The PIFS interval may be a longer duration than the SIFS interval.

AP 1 (610) may transmit a BA frame to STA 1 (620). In addition, the BA frame transmitted by AP 1 (610) to STA 1 (620) may include an indicator accepting or rejecting the RD indicated by STA 1. In an embodiment, the indicator accepting or rejecting the RD may be the more PPDU parameter (indicator). Specifically, when the more PPDU indicator is set to 1, the RD may be accepted, and when the more PPDU indicator is set to 0, the RD may be rejected. When AP 1 (610) accepts the RD indicated by STA 1 (620), AP 1 (610) may be granted an RD interval within the TXOP of STA 1 (620). The RD interval may be the reverse direction communication period as described above. Here, when the RDGO indicator in the uplink frame (601) transmitted by STA 1 (620) is set to 1, AP 1 (610) may perform frame transmission to STAs other than STA 1 within the RD interval. That is, AP 1 (610) may transmit at least one frame to at least one STA (e.g., STA 1, STA X, STA Y) within the RD interval. In addition, AP 1 (610) may segment a frame (e.g., PPDU) according to the frame segmentation related information within the RD interval. In an embodiment, when AP 1 (610) is required to segment PPDUs in units of 500 μs, the maximum length of frames transmitted by AP 1 (610) to the STAs may be 500 μs. In addition, when STA 1 (620) has indicated that the frame transmission interval of AP 1 is to be PIFS, the frames transmitted by AP 1 (610) may be transmitted separated by PIFS intervals. When the frame transmission interval of AP 1 (610) is set to a PIFS interval, STA 1 (620) may occupy the medium within the RD interval at a SIFS duration, which is shorter than PIFS, and an operation for revoking the TXOP may be possible.

As a specific embodiment, referring to FIG. 6B, the RD interval of AP 1 (610) may be equal to the end time of the TXOP of STA 1 (620). That is, AP 1 (610) may use the medium until the TXOP of STA 1 (620) expires. Here, AP 1 (610) may transmit a frame to STA X (631). AP 1 (610) may segment the frame to be transmitted to STA X (631) into two frames based on the frame segmentation related information indicated by STA 1 (620), and the segmented frames may be transmitted at PIFS intervals. Here, the acknowledgment policy (ACK policy) of the first frame among the segmented frames may be set to block acknowledgment (BlockAck). In an embodiment, the second frame among the segmented frames may be transmitted after a PIFS duration from the transmission end time of the first frame, and the acknowledgment policy (ACK policy) may be set to implicit BAR. In an embodiment, when AP 1 (610) continues transmission without terminating the RD interval, the more PPDU in the frame header of the frame to be transmitted may be set to 1. Accordingly, the more PPDU of the first frame and the second frame transmitted by AP 1 (610) to STA X (631) may be set to 1. When STA X (631) receives a frame whose acknowledgment policy is set to BlockAck, STA X (631) may record the reception status of the frame in the BlockAck scoreboard and may not transmit a response to the frame. On the other hand, when STA X (631) receives a frame (the second frame) whose acknowledgment policy is set to implicit BAR, STA X (631) may transmit a BA frame to AP 1 (610) after a SIFS duration from the reception end time of the frame. That is, the interval between frames may be a PIFS duration or a SIFS duration based on the acknowledgment policy. In an embodiment, AP 1 (610) may perform transmission to another STA (e.g., STA Y) using the RD interval after transmitting data frames to STA X (631), and accordingly, the more PPDU parameter of the second frame may be set to 1.

Referring to FIG. 6B, after transmitting two frames to STA X (631), AP 1 (610) may perform frame transmission to STA Y (632). In an embodiment, the frame transmitted by AP 1 (610) to STA Y (632) may be segmented into three frames, but this is merely one embodiment for convenience of explanation and may not be limited thereto.

After AP 1 (610) transmits two frames to STA X (631), AP 1 (610) may perform frame transmission to STA Y (632). The frame transmitted by AP 1 (610) to STA Y (632) may be segmented into three frames, and each of the segmented frames may be transmitted at PIFS intervals. When AP 1 (610) continues transmission without terminating the RD interval, the more PPDU in the frame header of the frame transmitted by AP 1 (610) may be set to 1. On the other hand, when AP 1 (610) transmits the last frame of the segmented frames, the more PPDU in the frame header may be set to 0.

In an embodiment, after AP 1 (610) transmits two frames to STA Y (632), STA 1 (620) may transmit an RD revoke request frame (602) to AP 1 (610) after a SIFS duration from the transmission end time of the second frame of AP 1 (610). The RD revoke request frame (602) may be a frame transmitted by STA 1 (620) to terminate the RD interval and use the remaining TXOP. The RD revoke request frame (602) may be any one of a quality of service (QoS) frame requesting RD revoke (e.g., a QoS Null frame indicated with RDG=0), an action frame, and other frames. When AP 1 (610) receives the RD revoke request frame (602) from STA 1 (620), AP 1 (610) may perform any one of the operations in Table 2 below.

TABLE 2
1. Prior to terminating RD interval use, AP 1 performs an operation
to receive BA frames from STA X and STA Y.
2. AP 1 immediately terminates RD interval use.

When AP 1 (610) performs the first operation in Table 2, AP 1 (610) may transmit at least one of a QoS Null frame, a BAR frame (e.g., a BAR frame or a multi-user (MU)-BAR frame), trigger frames, and a combination of the frames (e.g., combining and transmitting the frames in the form of an A-MPDU) to at least one STA (e.g., STA X and STA Y) after a SIFS duration from receipt of the RD revoke request frame (602), and may receive BA frames from the at least one STA. In an embodiment, when the frame transmitted by AP 1 (610) includes a more PPDU parameter, AP 1 (610) may set the more PPDU indicator to 0 to indicate that the RD is terminated. In an embodiment, AP 1 (610) may transmit a QoS Null frame (603) whose acknowledgment policy (ACK policy) is set to implicit BAR to STA Y (632). That is, STA Y (632) may receive a frame whose acknowledgment policy is set to implicit BAR from AP 1 (610), and STA Y (632) may transmit a BA frame (604) to AP 1 (610) after a SIFS duration from receipt of the frame. Since AP 1 (610) has received the RD revoke request frame (602) from STA 1 (620), upon receiving the BA frame (604), AP 1 (610) may terminate the RD interval. Thereafter, STA 1 (620) may use the remaining TXOP interval.

As another embodiment, when AP 1 (610) performs the second operation in Table 2, AP 1 (610) may no longer transmit frames. STA 1 (620) may detect that the medium is in an idle state for a PIFS duration, and based thereon, the remaining TXOP interval may be used by STA 1 (620). Within the remaining TXOP interval, STA 1 (620) may further transmit frames (e.g., UL data frames). Through the foregoing, STA 1 (620) may obtain an opportunity to use the TXOP again even after granting the RD interval to AP 1 (610), and efficiency may be increased in situations where STA 1 (620) needs to additionally transmit frames.

In addition, In an embodiment, when STA 1 (620) transmits an RD revoke request frame after a SIFS duration from the transmission end time of the frame of AP 1 (610), a collision may occur when STA X (631) or STA Y (632) transmits a BA frame depending on the acknowledgment policy (ACK policy) of the frame transmitted by AP 1 (610). To prevent the collision, STA 1 (620) may check the acknowledgment policy (ACK policy) included in the frame transmitted by the AP, and may refrain from transmitting the RD revoke frame (602) when the acknowledgment policy is set to implicit BAR. As another embodiment, STA 1 (620) may also refrain from transmitting the RD revoke frame (602) to prevent collisions in other cases where a collision may occur based on the frame transmitted by the AP, but the present disclosure is not limited to such embodiments.

As another embodiment, the acknowledgment policy (ACK policy) of frames transmitted by AP 1 (610) may be restricted so as not to be set to implicit BAR within the RD interval. That is, collisions caused by other STAs transmitting BA frames after a SIFS duration based on frames transmitted by AP 1 (610) may not occur. Accordingly, STA 1 (620) may transmit the RD revoke frame (602) after a SIFS duration from the transmission end time of the frame transmitted by AP 1 (610). When AP 1 (610) receives the RD revoke frame, AP 1 (610) may transmit at least one of a QoS Null frame, a BAR frame (e.g., a BAR frame or a multi-user (MU)-BAR frame), trigger frames, and a combination of the frames (e.g., combining and transmitting the frames in the form of an A-MPDU) to at least one STA (e.g., STA X and STA Y), and may receive BA frames from the at least one STA.

In addition, In an embodiment, when AP 1 (610) determines target STAs (e.g., STA 1, STA X, STA Y) to which frames are to be transmitted in the RD interval, the machine learning unit and machine learning algorithm of FIG. 3 and FIG. 4 described above may be used. As a specific embodiment, AP 1 (610) may always receive buffer status reports (BSRs) from STAs and may check queue information for data to be transmitted to the STAs. That is, AP 1 (610) may be aware of information regarding traffic to be received from or transmitted to the STAs. AP 1 (610) may use the traffic information as input to a machine learning algorithm (e.g., deep reinforcement learning (DRL)). That is, AP 1 (610) may utilize the traffic information as a state obtained from the environment of the DRL algorithm. The operation of AP 1 (610) of “scheduling traffic to STAs” may be regarded as an action of the DRL algorithm. In addition, transmitting more downlink frames to a specific STA may constitute an action of AP 1 (610).

FIG. 6C is a diagram illustrating an RD interval revoke method to which the present disclosure is applied. Referring to FIG. 6C, the environment may be one in which AP 1 (610), STA 1 (620), STA X (631), and STA Y (632) operate in a wireless LAN network. Here, STA X (631) and STA Y (632) may be STAs different from STA 1 (620). In addition, FIG. 6C is merely one embodiment for convenience of explanation and may not be limited to the described situation.

STA 1 (620) may perform an Enhanced Distributed Channel Access (EDCA) backoff, and may transmit a frame upon successful backoff. That is, STA 1 (620) may occupy a channel based on the EDCA backoff procedure and perform frame transmission on the occupied channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value and then decrement the backoff counter value. When the backoff counter value reaches zero based on the decrement of the backoff counter value, the EDCAF may perform frame transmission at the slot boundary of the slot at which the backoff counter value reaches zero. When the EDCAF of STA 1 determines frame transmission, an EDCA transmission opportunity (TXOP) may be granted to the EDCAF of STA 1 (620). That is, STA 1 (620) may be allocated a TXOP, and STA 1 (620) may initiate communication with other STAs within a transmission opportunity (TXOP) duration set within a predetermined TXOP limit to perform data transmission.

STA 1 (620) may transmit an uplink data frame (601) to AP 1 (610) in the first frame of the TXOP. AP 1 (710) may respond to STA 1 (720) with a block acknowledgment (BA) frame. STA 1 (620) may then transmit another uplink data frame (601) to AP 1 (610).

The uplink data frame (601) transmitted by STA 1 (620) may include at least one of an indicator indicating RD (e.g., RDG), an access category (AC) constraint indicator, and an RDG others (RDGO) indicator indicating whether RD is permitted to another STA. In an embodiment, the indicator indicating RD may be included in the HT Control field included in the MAC header of MPDUs (MAC protocol data units) included in the uplink data frame (601) transmitted by STA 1 (620). The information included in the HT Control field may be A-control information, which may be command and status (CAS) control. The CAS control may include an RDG/more PPDU bit. When STA 1 (720) indicates RD to AP 1 (710), the RDG/more PPDU bit may be set to 1. As another embodiment, the form of the indicator by which STA 1 (620) indicates RD to AP 1 (610) may vary. In an embodiment, the indicator indicating RD may be indicated by a single or a plurality of indicators, and is not limited to any specific form.

In addition, the indicator by which STA 1 (620) indicates RD to AP 1 (610) may further include frame segmentation related information (e.g., information for PPDU (PHY layer protocol data unit) segmentation). In an embodiment, the frame segmentation related information may be indicated in units of time. As a specific embodiment, the frame segmentation related information may be indicated in units of time unit (TU), where 1 TU equals 1024 μs. The frame segmentation related information indicated in TU units may be a real number, but is not limited to such embodiments.

As another embodiment, the frame related information may be indicated in units of frame duration (e.g., in units of μs, which is the frame duration unit of the MAC layer). As another embodiment, the frame segmentation related information may be indicated using the Duration/ID field of the MAC header included in the MPDU of the uplink data frame (601) that includes the indicator by which STA 1 (620) indicates RD to AP 1 (610). In an embodiment, when the information originally included in the Duration/ID field is 3600 μs and the aSlotTime is 9 μs (3600 mod 9=0), the corresponding value may be 0. Here, when the Duration/ID field value is 3599 μs, which is 1 μs less than the original Duration/ID field value, the corresponding value may be 8 (3599 mod 9=8). Here, STA 1 (620) may indicate the frame segmentation related information by excluding a portion of the time from the information that should be included in the original Duration/ID field. That is, AP 1 (610) may obtain values of 1 through 8 as frame segmentation related information from the Duration/ID field of 3592 through 3599 μs based on the remainder of 9 obtained through the modulo operation. When STA 1 (620) indicates values of 1 through 8, the frame segmentation length information may be information pre-configured between STA 1 (620) and AP 1 (610) according to the values of 1 through 8. However, the frame segmentation related information may be indicated by methods other than those described above, and is not limited to any specific form. Here, STA 1 (620) may indicate that the frame transmission interval of AP 1 (610) is to be a PIFS interval. The PIFS interval may be a longer duration than the SIFS interval.

AP 1 (610) may transmit a BA frame to STA 1 (620). In addition, the BA frame transmitted by AP 1 (710) to STA 1 (720) may include an indicator accepting or rejecting the RD indicated by STA 1. In an embodiment, the indicator accepting or rejecting the RD may be the more PPDU parameter (indicator). Specifically, when the more PPDU indicator is set to 1, the RD may be accepted, and when the more PPDU indicator is set to 0, the RD may be rejected. When AP 1 (610) accepts the RD indicated by STA 1 (620), AP 1 (610) may be granted an RD interval within the TXOP of STA 1 (620). The RD interval may be the reverse direction communication period as described above. Here, when the RDGO indicator in the uplink frame (601) transmitted by STA 1 (620) is set to 1, AP 1 (610) may perform frame transmission to STAs other than STA 1 within the RD interval. That is, AP 1 (610) may transmit at least one frame to at least one STA (e.g., STA 1, STA X, STA Y) within the RD interval. In addition, AP 1 (610) may segment a frame (e.g., PPDU) according to the frame segmentation related information within the RD interval. In an embodiment, when AP 1 (610) is required to segment PPDUs in units of 500 μs, the maximum length of frames transmitted by AP 1 (610) to the STAs may be 500 μs. In addition, when STA 1 (620) has indicated that the frame transmission interval of AP 1 is to be PIFS, the frames transmitted by AP 1 (610) may be transmitted separated by PIFS intervals. When the frame transmission interval of AP 1 (610) is set to a PIFS interval, STA 1 may occupy the medium within the RD interval at a SIFS duration, which is shorter than PIFS, and an operation for revoking the TXOP may be possible.

As a specific embodiment, referring to FIG. 6C, the RD interval of AP 1 (610) may be equal to the end time of the TXOP of STA 1 (620). That is, AP 1 (610) may use the medium until the TXOP of STA 1 (620) expires. Here, AP 1 (610) may transmit a multi-user (MU) frame (e.g., MU PPDU) to STA X (631) and STA Y (632) within the RD interval. The MU frame may be segmented and transmitted according to the frame segmentation related information indicated by STA 1 (620), and the transmission interval of the segmented MU frames may be a PIFS duration. When AP 1 (610) continues transmission without terminating the RD interval, the more PPDU in the frame header of the frame to be transmitted may be set to 1. On the other hand, when AP 1 (610) transmits the last frame of the segmented frames within the RD interval, the more PPDU in the frame header of the frame to be transmitted may be set to 0.

In an embodiment, when AP 1 (610) transmits MU frames, STA 1 (620) may transmit the RD revoke request frame (605) at a SIFS duration, which is shorter than the PIFS interval that is the transmission interval of the frames transmitted by AP 1 (610). The RD revoke request frame (605) may be a frame transmitted by STA 1 (620) to terminate the RD interval and use the remaining TXOP. The RD revoke request frame (605) may be any one of a QoS frame requesting RD revoke (e.g., a QoS Null frame indicated with RDG=0), an action frame, and other frames, and is not limited to any specific form. When AP 1 receives the RD revoke request frame, AP 1 (610) may perform any one of the operations in Table 3 below.

TABLE 3
1. Prior to terminating RD interval use, AP 1 performs an operation
to receive BA frames from STA X and STA Y.
2. AP 1 immediately terminates RD interval use.

When AP 1 (610) performs the first operation in Table 3, AP 1 (610) may transmit at least one of a QoS Null frame, a BAR frame (e.g., a BAR frame or a multi-user (MU)-BAR frame), trigger frames, and a combination of the frames (e.g., combining and transmitting the frames in the form of an A-MPDU) to at least one STA (e.g., STA X and STA Y) after a SIFS duration from receipt of the RD revoke request frame (605), and may receive BA frames from the at least one STA. In an embodiment, when the frame transmitted by AP 1 (610) includes a more PPDU parameter, AP 1 (610) may set the more PPDU indicator to 0 to indicate that the RD is terminated. In an embodiment, when AP 1 (610) transmits an MU-BAR frame to STA X (631) and STA Y (632), the MU-BAR frame (606) may be a trigger frame. Here, the MU-BAR frame (606) may indicate the subchannel (e.g., OFDMA subchannel, resource unit) on which STA X (631) and STA Y (632) are to transmit BA frames (607). STA X (631) and STA Y (632) may transmit BA frames (607) to AP 1 (610) after a SIFS duration based on the subchannel information indicated in the MU-BAR frame (606) of AP 1 (610). When AP 1 (610) receives the BA frames (607), the RD interval may be terminated, and STA 1 (620) may utilize the remaining TXOP interval again.

As another embodiment, when AP 1 (610) performs the second operation in Table 3, AP 1 (610) may no longer transmit frames. STA 1 (620) may detect that the medium is in an idle state for a PIFS duration, and based thereon, the remaining TXOP interval may be used by STA 1 (620). Within the remaining TXOP interval, STA 1 (620) may further transmit frames (e.g., UL data frames). Through the foregoing, STA 1 (620) may obtain an opportunity to use the TXOP again even after granting the RD interval to AP 1 (610), and efficiency may be increased in situations where STA 1 (620) needs to additionally transmit frames.

In addition, In an embodiment, when AP 1 (610) determines target STAs (e.g., STA 1, STA X, STA Y) to which frames are to be transmitted in the RD interval, the machine learning unit and machine learning algorithm of FIG. 3 and FIG. 4 described above may be used. As a specific embodiment, AP 1 (610) may always receive buffer status reports (BSRs) from STAs and may check queue information for data to be transmitted to the STAs. That is, AP 1 (610) may be aware of information regarding traffic to be received from or transmitted to the STAs. AP 1 (610) may use the traffic information as input to a machine learning algorithm (e.g., deep reinforcement learning (DRL)). That is, AP 1 (710) may utilize the traffic information as a state obtained from the environment of the DRL algorithm. The operation of AP 1 (610) of “scheduling traffic to STAs” may be regarded as an action of the DRL algorithm. In addition, transmitting more downlink frames to a specific STA or triggering uplink frames may constitute actions of AP 1 (610). In addition, In an embodiment, AP 1 (610) may schedule frames to the STAs and subsequently collect traffic information from each of the STAs and AP 1 (610). The collected traffic information of AP 1 (610) may be regarded as a reward of the DRL algorithm. AP 1 (610) may train the agent of AP 1 (i.e., the agent of the DRL algorithm) in a direction that maximizes the reward. In an embodiment, the direction of maximizing the reward may be appropriate scheduling of traffic, but may not be limited thereto. Through the foregoing, AP 1 (610) may perform optimal scheduling operations in the RD interval (e.g., selection of the optimal STA to be scheduled and uplink frame scheduling).

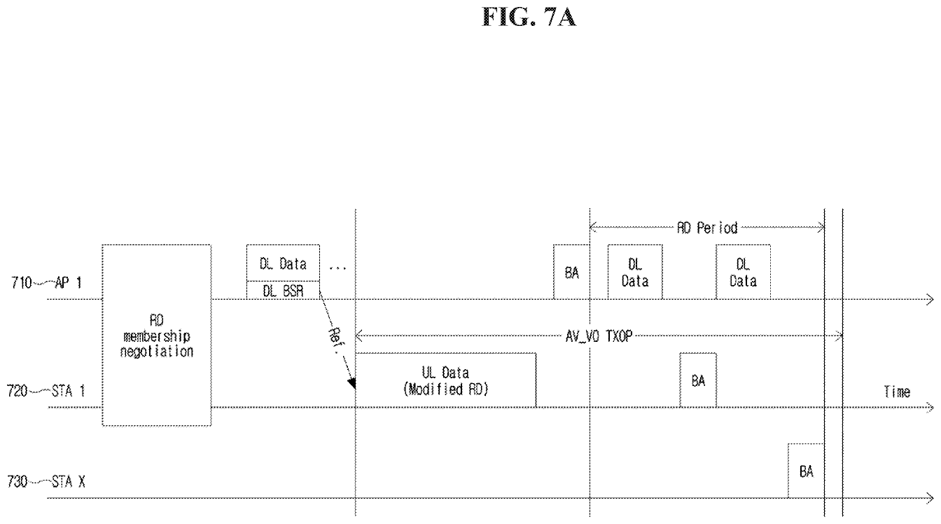

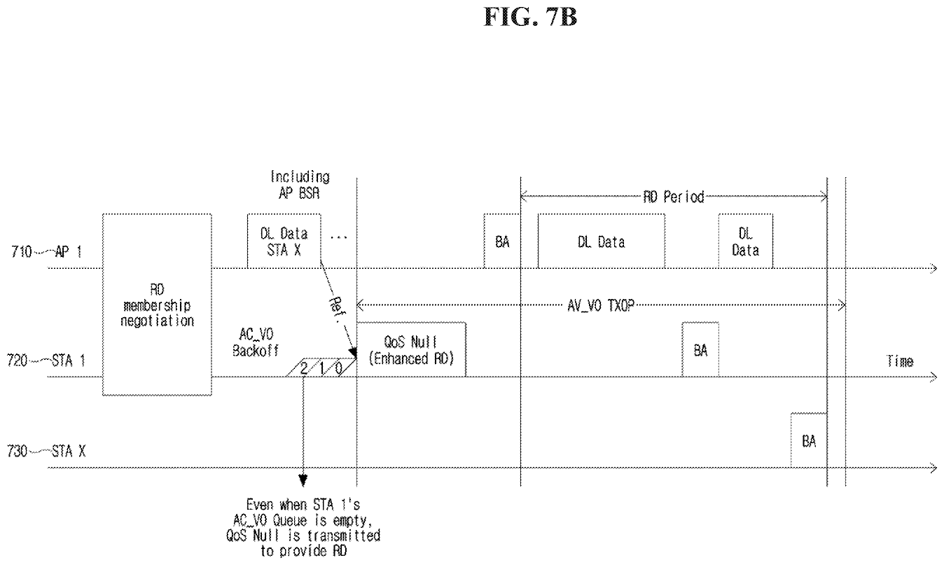

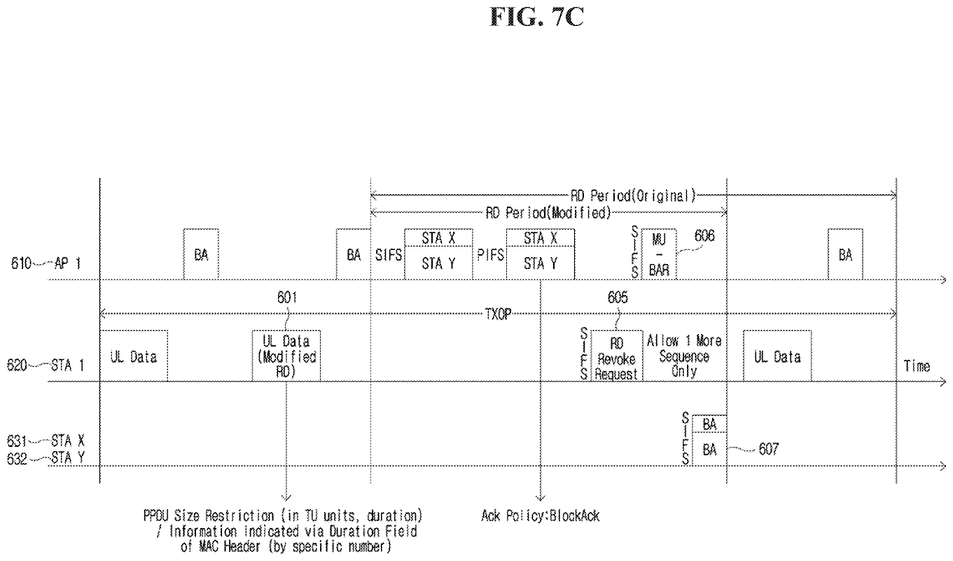

FIG. 7A and FIG. 7B are diagrams illustrating a reverse direction transmission inducement scheme of a STA to which the present disclosure is applied.

In a WLAN, an AP (710) may serve as an access point to a wide-area network (WAN) while communicating with a plurality of STAs in a one-to-many manner. Accordingly, the AP (710) may require more transmission opportunities than non-AP STAs (720); however, in a WLAN, both the AP (710) and non-AP STAs (720) may have equal channel access probabilities. Considering the foregoing, allowing the AP (710) to be provided with more transmission opportunities than non-AP STAs (720) so as to balance the downlink (DL) transmission volume of the AP (710) and the uplink (UL) transmission volume of the STAs may contribute to an overall improvement in network performance. Here, taking into account the issue, the transmission opportunity (TXOP) acquired by the STAs may be utilized by the AP (710) for DL transmission via reverse direction (RD) transmission, and the method therefor is described below.

Referring to FIG. 7A, STA 1 (720) may perform an Enhanced Distributed Channel Access (EDCA) backoff, and may transmit a frame upon successful backoff. That is, STA 2 (720) may occupy a channel based on the EDCA backoff procedure and perform frame transmission on the occupied channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value and then decrement the backoff counter value. When the backoff counter value reaches zero based on the decrement of the backoff counter value, the EDCAF may perform frame transmission at the slot boundary of the slot at which the backoff counter value reaches zero. When the EDCAF of STA 1 determines frame transmission, an EDCA transmission opportunity (TXOP) may be granted to the EDCAF of STA 1 (720). That is, STA 1 (720) may be allocated a TXOP, and STA 1 (720) may initiate communication with other STAs within a transmission opportunity (TXOP) duration set within a predetermined TXOP limit to perform data transmission and reception.

STA 1 (720) may transmit an uplink data frame to AP 1 (710) in the first frame of the TXOP. AP 1 (710) may respond to STA 1 (720) with a block acknowledgment (BA) frame. STA 1 (720) may then transmit another uplink data frame to AP 1 (710). Here, the indicator indicating RD may be included in the HT Control field included in the MAC header of the MPDUs included in the uplink data frame transmitted by STA 1 (720). The information included in the HT Control field may be A-control information, which may be command and status (CAS) control. The CAS control may include an RDG/more PPDU bit. STA 1 (720) may grant permission for the counterpart in communication to use the configured transmission opportunity duration TXOP, which may be a reverse direction transmission operation or reverse direction communication. In an embodiment, the STA that initiates reverse direction communication may be an RD initiator, and the STA that is allocated the reverse direction communication may be an RD responder. In an embodiment, STA 1 (720) may authorize reverse direction communication within the configured TXOP. To authorize reverse direction communication, the header of the data to be transmitted may include an RDG indicator, an AC constraint indicator, and the AC of the data to be transmitted. The RDG indicator may indicate whether a STA (e.g., AP 1) receiving data within the TXOP duration (e.g., TXOP (Original)) is permitted to transmit data in the reverse direction. As a specific embodiment, when the RDG is set to 1, a STA (e.g., AP 1) receiving data within the TXOP duration may transmit reverse direction data to another STA. On the other hand, when the RDG is set to 0, a STA (e.g., AP 1) receiving data within the TXOP duration may not transmit reverse direction data to another STA.

When the RDG is set to 1, the RD initiator may additionally include a reverse direction grant others (RDGO) indicator in the header for transmission. The RDGO indicator may indicate the target STA to which reverse direction data may be transmitted. When the RDGO is set to 0, the RD responder may perform reverse direction data transmission only to the RD initiator. On the other hand, when the RDGO is set to 1, the RD responder may also perform data transmission to STAs other than the RD initiator. In an embodiment, when the RDGO indicator is not included in the header, the RD responder may perform reverse direction data transmission only to the RD initiator. That is, the RD responder may operate in the same manner as when the RDGO is set to 0.

The AC constraint indicator may indicate whether a STA transmitting data via reverse direction communication is permitted to transmit only data of the same AC type as the data transmitted with the RDG set. When the AC constraint indicator is set to 1, a STA transmitting data via reverse direction communication may transmit only AC data of the same type as the data transmitted with the RDG set. On the other hand, when the AC constraint indicator is set to 0, a STA transmitting data via reverse direction communication may transmit AC data of a different type from the data transmitted with the RDG set. In an embodiment, when the AC constraint indicator is set to 0, a STA transmitting data via reverse direction communication may perform data transmission of a different AC, and accordingly, the TXOP limit of the different AC may be applied.

Here, STAs (RD terminals) that induce reverse direction transmission of the AP (710) may determine the reverse direction transmission method and specific operations through prior negotiation with the AP (710). Specifically, RD terminals may become RD terminals through an RD membership negotiation process. The RD membership negotiation may be performed through the exchange of separate action frames. As another embodiment, the RD membership negotiation may be performed during another association process, and may not be limited to any specific form.

In an embodiment, the RD membership negotiation may be a procedure in which a STA determines at least one of RD operation participation level information, time information regarding RD operation participation, and parameter information based on RD operation. As a specific embodiment, the time information regarding RD operation participation, which is information indicating the duration of RD operation participation, may be an RD membership timer. In an embodiment, when a STA performs the RD operation again while the RD membership timer is being applied, the RD membership timer may be restarted. That is, the initially configured RD membership timer value may be reset and restarted.

When RD membership negotiation is performed, it may be determined whether the STA participating in the RD membership negotiation mandatorily or optionally participates in the RD operation. In an embodiment, when a STA mandatorily participates in the RD operation, the STA may induce reverse direction transmission of the AP every time the conditions enabling RD operation are satisfied within the TXOP acquired by the STA. On the other hand, when a STA optionally participates in the RD operation, the STA may selectively perform the RD operation for each TXOP it acquires. In addition, other parameter information included in the negotiation may include a flag bit indicating whether AC restriction is considered in the RD operation performed after the negotiation. In an embodiment, when the flag bit is not included, STAs performing the RD operation at the AP may apply a condition that does not restrict the AC. As another embodiment, parameters included in the negotiation may indicate whether STAs participating in the RD operation are permitted to access the channel with a different EDCA parameter set from that of other STAs. Here, when the parameter permits STAs participating in the RD operation to access the channel with a different EDCA parameter set from that of other STAs, the AP may transmit a separate EDCA parameter set for STAs participating in the RD operation. In addition, the AP may transmit its own buffer status report (BSR) information to the STA. When the AP transmits its own BSR to the STA, the AP may transmit, together with the BSR, information indicating the time at which the BSR information expires.

In an embodiment, in conventional wireless LAN systems, non-AP STAs were required to always transmit buffer status report (BSR) information in QoS data frames they transmit. Accordingly, the AP may be able to continuously track the buffer status of non-AP STAs. On the other hand, the AP did not perform the operation of notifying non-AP STAs of BSR for general DL data other than traffic indication map (TIM) information transmitted for power saving purposes. Therefore, STAs participating in the RD operation were unable to determine whether the AP requires reverse direction transmission. In addition, since STAs participating in the RD operation cannot be aware of the amount of data required by the AP for RD transmission and the transmission time required for reverse direction transmission, the efficiency of the RD operation may be degraded.

Taking into account the issues, the AP may include its own BSR information in DL transmission frames for transmission. The BSR information may be included in the QoS control field of all or specific QoS data (or Null) frames for transmission. As another embodiment, the BSR information may be included in the A-control field included in the header of a MAC frame. As another embodiment, the AP may transmit the BSR information via a separate action frame. As another embodiment, the AP may transmit the BSR information as a specific field in the preamble of a PPDU. As a specific embodiment, when the AP transmits an MU PPDU via DL MU, STAs participating in the RD operation may not be able to receive the MAC frame, and therefore a condition may be added requiring that the BSR information be transmitted in the preamble within the MU PPDU transmitted via DL MU. As another embodiment, when the AP transmits an MU PPDU via DL MU, the AP may allocate at least one resource unit (RU) with a broadcast AID to transmit the BSR, but the present disclosure may not be limited to such embodiments.

Here, the BSR information of the AP may include at least one of total data size information present in the queue of the AP and per-AC data size information. As another embodiment, the BSR information of the AP may include information excluding the size of buffered units (BUs) transmitted to STAs in power saving mode. In an embodiment, the BSR information of the AP may be size information in specific units (e.g., octets). In addition, whether data of a type corresponding to the information included in the BSR information exists may be indicated through 1-bit indication information, and is not limited to any specific form.

In an embodiment, the DL transmission of the AP may result in different transmission lengths for each MCS supported by the receiving STA. Accordingly, the AP may transmit time information required for DL transmission as BSR information instead of data size. As a specific embodiment, the AP may include in the BSR transmission time information indicating the duration for which reverse direction transmission is to be performed in the next RD transmission. As another embodiment, the BSR may include minimum time information required for reverse direction transmission. Here, the information may be per-AC information.

As a specific embodiment, when a STA has negotiated to mandatorily participate in the RD operation, the STA may collect as much BSR information from the AP as possible. Accordingly, a STA that has negotiated to mandatorily participate in the RD operation may attempt to receive all frames that may include BSR transmitted from the AP. In an embodiment, a STA performing the RD operation may check the reverse direction transmission related data of the AP (710) based on the most recently and successfully received BSR of the AP. When the STA performing the RD operation determines that reverse direction transmission related data of the AP exists, the STA performing the RD operation may perform the RD operation. On the other hand, when the AP does not satisfy the minimum time condition required for RD transmission, the STA performing the RD operation may not perform the RD operation.

In addition, when application of AC restriction for RD is indicated during the negotiation process, the STA performing the RD operation may determine whether RD is feasible based on the AC conditions of the TXOP. In an embodiment, when the BSR information (per AC) received by the STA has expired according to a timer condition, a condition may be added that the STA performing the RD operation does not perform the RD operation. In an embodiment, when it is feasible for the STA performing the RD operation to transmit all data or transmission time specified in the BSR of the AP within the corresponding RD based on whether AC restriction is applied, the STA performing the RD operation may set the length of the TXOP as the sum of the time required for all of its own transmissions and the time required for all RD transmissions. As another embodiment, all TXOPs that induce reverse direction transmission of the AP may always be set to the TXOP limit value of the AC of the corresponding TXOP, but the present disclosure may not be limited to such embodiments.

FIG. 7B is a diagram illustrating a reverse direction transmission method to which the present disclosure is applied. Referring to FIG. 7B, in a post-backoff situation where no packets exist in the transmission queue, a STA may not attempt channel access for TXOP acquisition while maintaining the backoff counter at 0. That is, when no packets exist in the transmission queue after a backoff, the STA may not attempt to occupy the channel. However, as described above, a STA that has performed RD membership negotiation may attempt channel access to acquire a TXOP for inducing RD transmission of the AP based on the BSR information of the AP. In an embodiment, when a STA that has performed RD membership negotiation receives BSR information of the AP during the post-backoff process (e.g., the backoff process performed after the queue for each AC is emptied), the STA that has performed RD membership negotiation may perform an EDCA backoff operation even when no packets exist in its own transmission queue. That is, the STA that has performed RD membership negotiation may perform an EDCA backoff operation by treating the situation as if data for transmission exists in its own transmission queue.

When AC restriction is considered in RD membership and the AP transmits BSR information for per-AC RD, the STA that has performed RD membership negotiation may treat the situation as if data for transmission exists in the queue only for the AC corresponding to the RD transmission. Here, RD transmission may not be limited to permitting RD only for the same AC as the AC of the TXOP. Since RD transmission may permit RD transmission of ACs higher than the AC of the TXOP, the same condition may be applied. As a specific embodiment, AP (710) may notify the STA that has performed RD membership negotiation that RD data for AC_VI exists. Here, for a TXOP corresponding to AC_VI/BE/BK, AC_VI transmission of AP (710) may be permitted; however, for a TXOP corresponding to AC_VO, AC_VI transmission in RD may not be permitted. Accordingly, the STA that has performed RD membership negotiation may perform a backoff operation by treating the situation as if data exists in the transmission queue for AC_VI/BE/BK, but may not treat the situation as if data exists in the transmission queue for AC_VO.

In an embodiment, when a STA acquires BSR information of the AP via the TXOP of another STA or AP while the backoff counter is maintained at 0 due to no data existing in the transmission queue, the STA may find itself in a situation where data is treated as existing in the transmission queue in the middle of a TXOP. In the case, the STA may have a high probability of causing a collision with other STAs in the same situation immediately after the TXOP ends. Accordingly, when a STA acquires BSR information of AP (710) in the middle of the TXOP of another STA or AP while maintaining the backoff counter at 0, the STA may need to reset the backoff counter of the corresponding AC (e.g., setting the counter uniformly at random within [0, CW]) when attempting channel access for reverse direction transmission. As another method, when a STA acquires BSR information of AP (710) in the middle of the TXOP of another STA or AP while maintaining the backoff counter at 0, and the backoff counter is already set to a non-zero value, the STA does not need to reset the backoff counter.

Referring to FIG. 7B, when a STA that has performed RD membership negotiation acquires a TXOP for reverse direction transmission of the AP in a situation where it has no data to transmit, the STA that has performed RD membership negotiation may indicate reverse direction transmission via a QoS Null frame as the very first frame of the TXOP, excluding RTS/CTS frames. Here, the conditions related to TXOP length configuration and AC restriction application may be applied in the same manner as in FIG. 7A, and are not limited to any specific form. In the foregoing, the operations of STAs joining AP 1 for RD membership and authorizing reverse direction transmission may be determined based on the machine learning unit and machine learning algorithm of FIG. 3 and FIG. 4. In an embodiment, STAs may receive a buffer status report (BSR) from the AP, and may determine whether the STAs should permit reverse direction transmission to the AP. STAs may use the traffic information obtained from the BSR of the AP as input to a machine learning algorithm (e.g., deep reinforcement learning (DRL)). That is, STAs may utilize the traffic information as a state obtained from the environment of the DRL algorithm. The operation of STAs of “scheduling reverse direction transmission to the AP” may be regarded as an action of the DRL algorithm. In addition, the AP may perform reverse direction frame transmission to the STAs, and thereafter the AP may transmit a BSR to notify the STAs of traffic information. STAs may collect the traffic information of the AP, and the collected traffic information may be regarded as a reward of the DRL algorithm. STAs may train the agents of the STAs (i.e., the agents of the DRL algorithm) in a direction that maximizes the reward. Here, maximizing the reward may correspond to appropriate scheduling of traffic, and STAs may perform optimal RD operations with AP (710).

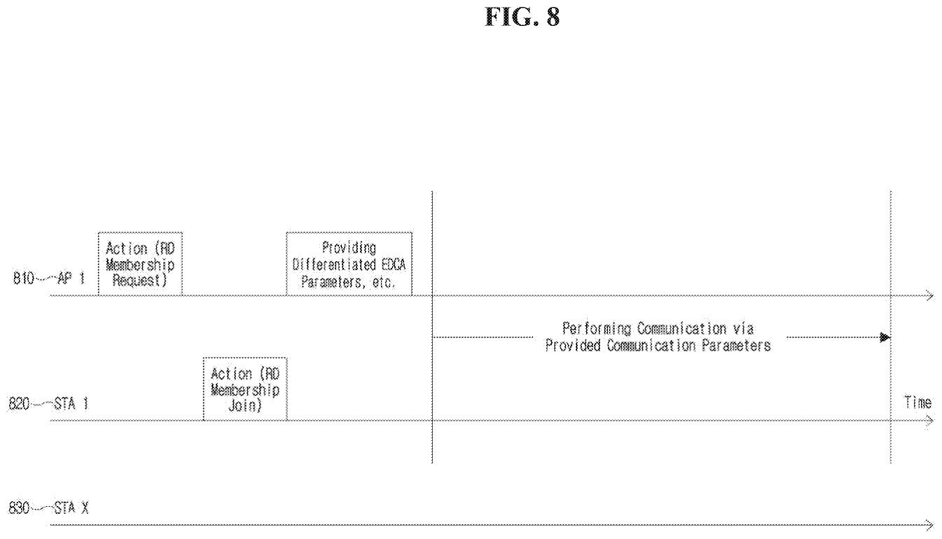

FIG. 8 is a diagram illustrating a method of applying differentiated channel access parameters for STAs for inducing reverse direction transmission of a STA to which the present disclosure is applied. Referring to FIG. 8, a STA may perform RD membership negotiation with the AP in the same or similar manner as in FIG. 7A and FIG. 7B. In the case, the STA may share a pre-configured RD membership timer with the AP. Here, a STA performing the RD operation that induces reverse direction transmission may contribute to the network in a direction that alleviates the DL data of the AP. Taking the foregoing into consideration, differentiated channel access parameters may be applied to STAs performing the RD operation. In an embodiment, in a WLAN, when the AP induces UL MU transmission from a STA, the STA participating in the UL MU transmission may access the channel with a lower probability through the application of MU EDCA parameters. Here, when MU EDCA parameters are applied to a STA performing the RD operation, the reverse direction transmission opportunities of the AP based on the STA performing the RD operation may be reduced. In an embodiment, the MU EDCA parameters may be parameters that are more disadvantageous for channel access than the default EDCA parameters. Taking the foregoing into consideration, the MU EDCA parameters may not be applied to STAs performing the RD operation.

As a specific embodiment, when the conditions for applying MU EDCA parameters to a STA that has performed RD membership negotiation are satisfied, the application of MU EDCA parameters to the STA that has performed RD membership negotiation may be exempted or deferred for a pre-configured timer duration (i.e., the RD membership timer). In an embodiment, the pre-configured timer duration may be set based on parameters exchanged during the RD membership negotiation process. In an embodiment, when the pre-configured timer is applied, the STA that has performed RD membership negotiation may induce reverse direction transmission of the AP before the timer expires. In the case, the STA may reset the timer value to the initial value and may again defer the application of MU EDCA parameters. That is, the STA may restart with the timer value configured in the RD membership negotiation. On the other hand, when the pre-configured timer expires, the STA may be required to apply the MU EDCA parameters.

As another embodiment, when MU EDCA parameters are being applied to a STA, if the STA successfully induces reverse direction transmission of the AP, the application of MU EDCA parameters may be lifted. In the case, the MU EDCA parameters may be changed to default EDCA parameters, and the backoff counter value may be reset after being changed to the default EDCA parameters.

As another embodiment, STAs that have performed RD membership may perform channel access based on a separate EDCA parameter set. In an embodiment, STAs may receive a separate EDCA parameter set during the RD membership negotiation process, or may receive a separate EDCA parameter set via a separate frame after the RD membership negotiation process is completed.

In an embodiment, when STAs join the AP for RD membership, the EDCA parameters may be determined based on the machine learning unit and machine learning algorithm of FIG. 3 and FIG. 4. The AP may utilize the traffic conditions of the network (e.g., load ratio, delay, packet error rate) as a state obtained from the environment of the DRL algorithm. The operation of the AP of selecting appropriate channel access parameters is regarded as an action of the DRL algorithm. STAs may communicate based on the channel access parameters selected by the AP, and the AP may again collect the traffic conditions of the network. The collected traffic information may be regarded as a reward of the DRL algorithm. The AP may train the agent of the AP (i.e., the agent of the DRL algorithm) in a direction that maximizes the reward. Here, the direction of maximizing the reward may mean appropriate scheduling of traffic, and the AP may indicate optimal channel access parameters to STAs participating in the RD membership.

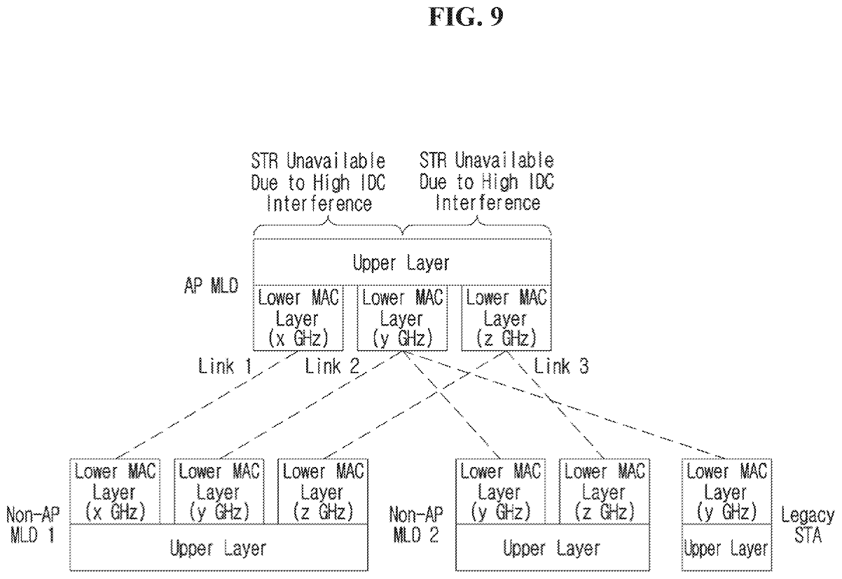

In addition, In an embodiment, in a WLAN, a STA may support enhanced multi-link single-radio (EMLSR) operation, and operations based thereon may be required. FIG. 9 is a diagram illustrating multiple links configured between multi-link devices (MLDs) to which the present disclosure is applied. Referring to FIG. 9, an MLD may have one medium access control (MAC) address. In an embodiment, an MLD may refer to an AP MLD and/or a non-AP MLD. The MAC address of an MLD may be used in the multi-link setup procedure between a non-AP MLD and an AP MLD. The MAC address of the AP MLD may differ from the MAC address of the non-AP MLD. Access points associated with the AP MLD may have different MAC addresses, and stations associated with the non-AP MLD may have different MAC addresses. Access points within the AP MLD having different MAC addresses may each be responsible for a respective link and may serve the role of an independent access point (AP).

Stations within the non-AP MLD having different MAC addresses may each be responsible for a respective link and may serve the role of an independent station (STA). A non-AP MLD may also be referred to as a STA MLD. An MLD may support simultaneous transmit and receive (STR) operation. In this case, the MLD may perform a transmission operation on link 1 and a reception operation on link 2. An MLD supporting STR operation may be referred to as an STR MLD (e.g., STR AP MLD, STR non-AP MLD). In an embodiment, a link may refer to a channel or a band. A STA that does not support STR operation may be referred to as a non-STR (NSTR) AP MLD or an NSTR non-AP MLD (or NSTR STA MLD), but is not limited to such embodiments.

An MLD may transmit and receive frames over multiple links by using a non-contiguous bandwidth extension scheme (e.g., 80 MHz+80 MHz). Multi-link operation may include multi-band transmission. An AP MLD may include a plurality of access points, and the plurality of access points may operate on different links. Each of the plurality of access points may perform the function(s) of a lower MAC layer. Each of the plurality of access points may be referred to as a “communication node” or a “lower entity.” A communication node (i.e., an AP) may operate under the control of an upper layer (or the processor (110) shown in FIG. 1). A non-AP MLD may include a plurality of STAs, and the plurality of STAs may operate on different links. Each of the plurality of STAs may be referred to as a “communication node” or a “lower entity.” A communication node (i.e., a STA) may operate under the control of an upper layer (or the processor (110) shown in FIG. 1).

An MLD may perform communication in multiple bands. In an embodiment, an MLD may perform communication using a 40 MHz bandwidth in the 2.4 GHz band according to a channel extension scheme (e.g., a bandwidth extension scheme), and may perform communication using a 160 MHz bandwidth in the 5 GHz band according to a channel extension scheme. An MLD may perform communication using a 160 MHz bandwidth in the 5 GHz band and may perform communication using a 160 MHz bandwidth in the 6 GHz band. One frequency band (e.g., one channel) used by an MLD may be defined as one link. Alternatively, a plurality of links may be configured in one frequency band used by the MLD. In an embodiment, an MLD may configure one link in the 2.4 GHz band and two links in the 6 GHz band. Each link may be referred to as a first link, a second link, a third link, and so on. Alternatively, each link may be referred to as link 1, link 2, link 3, and so on. Link numbers may be configured by the access point, and an identifier (ID) may be assigned to each link, but the present disclosure may not be limited to such embodiments.

An MLD (e.g., an AP MLD and/or a non-AP MLD) may configure multiple links by performing an association procedure and/or a negotiation procedure for multi-link operation. In the case, the number of links and/or the link to be used among the multiple links may be configured. A non-AP MLD (e.g., a STA) may identify band information through which communication with the AP MLD is possible. In the negotiation procedure for multi-link operation between the non-AP MLD and the AP MLD, the non-AP MLD may configure one or more links among the links supported by the AP MLD for use in multi-link operation. A STA that does not support multi-link operation (e.g., an IEEE 802.11a/b/g/n/ac/ax station) may be connected to one or more links among the multiple links supported by the AP MLD.

When the band spacing between multiple links (e.g., the band spacing between link 1 and link 2 in the frequency domain) is sufficient, the MLD may perform STR operation. In an embodiment, the MLD may transmit PPDU (physical layer convergence procedure (PLCP) protocol data unit) 1 using link 1 among the multiple links, and may receive PPDU 2 using link 2 among the multiple links. On the other hand, when the band spacing between multiple links is insufficient and the MLD performs STR operation, in-device coexistence (IDC) interference, which is interference between multiple links, may occur. Accordingly, when the band spacing between multiple links is insufficient, the MLD may not be able to perform STR operation. A link pair having the interference relationship may be a non-simultaneous transmit and receive (NSTR) limited link pair. Here, the MLD may be an NSTR AP MLD or an NSTR non-AP MLD.

In an embodiment, multiple links including link 1, link 2, and link 3 may be configured between the AP MLD and non-AP MLD 1. When the band spacing between link 1 and link 3 is sufficient, the AP MLD may perform STR operation using link 1 and link 3. That is, the AP MLD may transmit a frame using link 1 and may receive a frame using link 3. When the band spacing between link 1 and link 2 is insufficient, the AP MLD may not be able to perform STR operation using link 1 and link 2. When the band spacing between link 2 and link 3 is insufficient, the AP MLD may not be able to perform STR operation using link 2 and link 3.

Meanwhile, in the access procedure between a STA and an AP in a wireless LAN system, a negotiation procedure for multi-link operation may be performed. A device supporting multiple links (e.g., an AP or a STA) may be referred to as a multi-link device (MLD). An access point supporting multiple links may be referred to as an AP MLD, and a STA supporting multiple links may be referred to as a non-AP MLD or a STA MLD. An AP MLD may have a physical address (e.g., a MAC address) for each link. Here, the AP MLD may be implemented as if a separate AP exists for each link. A plurality of APs may be managed within one AP MLD. Accordingly, coordination among a plurality of APs belonging to the same AP MLD may be possible. A STA MLD may have a physical address (e.g., a MAC address) for each link. A STA MLD may be implemented as if a separate STA exists for each link. A plurality of STAs may be managed within one STA MLD. Accordingly, coordination among a plurality of STAs belonging to the same STA MLD may be possible.

In an embodiment, AP1 of the AP MLD and STA1 of the STA MLD may each be responsible for the first link and may communicate using the first link. AP2 of the AP MLD and STA2 of the STA MLD may each be responsible for the second link and may communicate using the second link. STA2 may receive status change information regarding the first link on the second link. In this case, the STA MLD may aggregate information received on each link (e.g., status change information) and may control the operation performed by STA1 based on the aggregated information.

Next, methods of transmitting and receiving data in a wireless LAN system will be described. Even when a method performed at a first communication node among communication nodes (e.g., transmission or reception of a signal) is described, a corresponding second communication node may perform a method corresponding to the method performed at the first communication node (e.g., reception or transmission of a signal). That is, when the operation of a STA is described, the corresponding AP may perform an operation corresponding to the operation of the STA. Conversely, when the operation of an AP is described, the corresponding STA may perform an operation corresponding to the operation of the AP. In an embodiment, the operation of a STA may be interpreted as the operation of a STA MLD, and the operation of a STA MLD may be interpreted as the operation of a STA. In addition, the operation of an AP may be interpreted as the operation of an AP MLD, and the operation of an AP MLD may be interpreted as the operation of an AP.

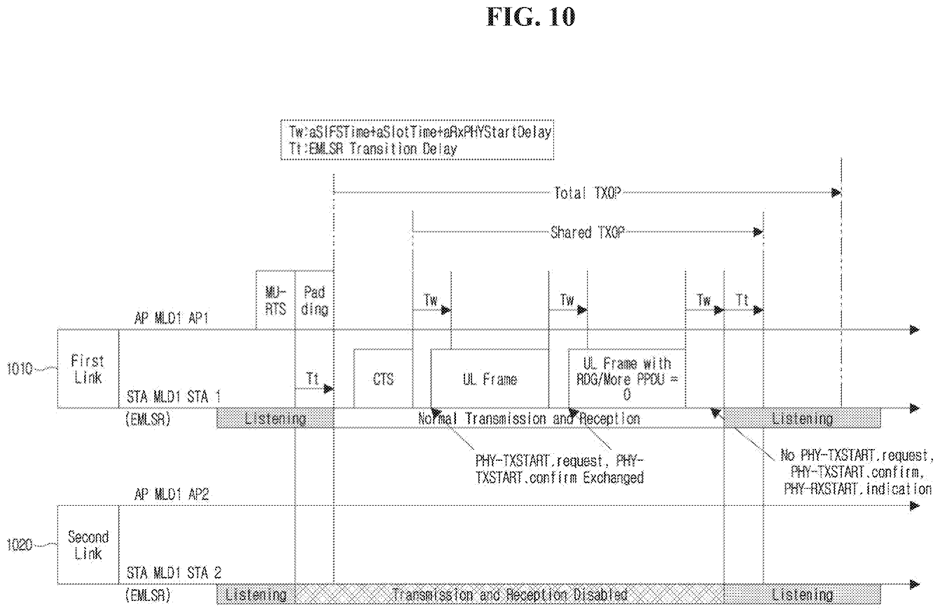

FIG. 10 is a diagram illustrating a frame exchange method during enhanced multi-link single radio operation of a wireless LAN to which the present disclosure is applied. Referring to FIG. 10, the AP operating on the first link (1010) of AP MLD 1 may be referred to as AP 1, and the AP operating on the second link (1020) may be referred to as AP 2. The STA operating on the first link (1010) of STA MLD 1 may be referred to as STA 1, and the STA operating on the second link (1020) of STA MLD 1 may be referred to as STA 2. STA MLD 1 may be an enhanced multi-link single radio (EMLSR) STA MLD. The EMLSR STA MLD may perform EMLSR operation, and STA MLD 1 may perform EMLSR operation on the first link (1010) and the second link (1020). STAs on each link of STA MLD 1 may be referred to as EMLSR STAs.

In an embodiment, STA 1, which is the STA of EMLSR STA MLD 1 operating on the first link (1010), may be referred to as an EMLSR STA. The EMLSR STA MLD may initiate or terminate the EMLSR operation or mode by exchanging an EML operating mode notification (OMN) frame with the AP MLD. Before the EMLSR mode is terminated or initiated, at a given time, either STA 1 or STA 2 may perform normal transmission and reception operations and a listen operation using one transceiver (e.g., a radio). STA 1 and STA 2 may not simultaneously perform normal transmission and reception operations. When the EMLSR STA MLD initiates the EMLSR mode through EML OMN frame exchange, it may perform EMLSR mode operation on the EMLSR links negotiated with the AP MLD. The EMLSR mode operation may consist of a listen operation (e.g., listening operation) that listens for whether an initial control frame of a predetermined format is being transmitted on the EMLSR links, and a normal transmission and reception operation (e.g., EMLSR operation) that transitions all receiving radios (e.g., receiving antennas) or transceiving radios (e.g., transceiving antennas) operating on other links to the link on which the initial control frame was transmitted, and receives frames transmitted from the AP MLD.

When the EMLSR STA MLD transmits to the AP MLD, it may transition all radios to one of the EMLSR links for transmission. STA 1 may perform normal transmission and reception operations and a listen operation. STA 1 may transmit and receive all frames in the normal transmission and reception operation. STA 1 may receive only frames of a predetermined format in the listen operation. The frame of a predetermined format may be an initial control frame. The initial control frame may be an MU-RTS trigger frame or a BSRP trigger frame. The MU-RTS trigger frame may also be referred to as an MU-RTS frame in the present disclosure. STA 2 affiliated with EMLSR STA MLD 1 may operate in a listen operation when the operational state of STA 1 is the listen operation. Here, when the operational state of STA 1 is the normal transmission and reception operation, STA 2 may be in a transmission and reception disabled state. During the transition time Tt required when STA 1 transitions from the listen operation to the normal transmission and reception operation, or from the normal transmission and reception operation to the listen operation, STA 2 may be in a transmission and reception disabled state. The operational state changes may be equally applicable to STA 1 when STA 2 is in the listen operation or the normal transmission and reception operation.

In an embodiment, on the first link (1010), AP 1 may perform a channel access operation (e.g., EDCA backoff operation) to acquire a TXOP, which is a time interval during which a plurality of frames may be transmitted. On the first link (1010), STA 1 may receive an initial control frame (e.g., an MU-RTS trigger frame). The initial control frame may include padding bits and/or a padding field that extends the length of the frame in consideration of the radio switching time of STA 1. STA 1 may respond with a CTS frame after a SIFS duration from the completion of reception of the initial control frame. At this time, STA 1 may wait for a Tw duration. The Tw duration is a duration consisting of ‘aSIFSTime+aSlotTime+aRxPHYStartDelay’. The aRxPHYStartDelay may be 20 μs.

The Tw duration may start when one of the following conditions, <Tw Condition 1>, <Tw Condition 2>, and <Tw Condition 3> in Table 5, is satisfied after the reception of the initial control frame.

In addition, when Tw is initiated after the completion of reception of the initial control frame, STA 1 may not operate in the normal transmission and reception operation and may transition to the listen operation if the <Listen> condition in Table 4 is satisfied during the Tw duration.

```
TABLE 4
  <Tw Condition 1>
  Starts at the completion of transmission of a PPDU when the PPDU transmitted
by the STA is a response to the most recently received frame from the AP.
  <Tw Condition 2>
  Starts at the completion of reception of a PPDU when the PPDU received from
the AP or another STA includes a frame that does not require an immediate response.
  <Tw Condition 3>
  Starts at the completion of transmission of a PPDU when the PPDU transmitted
by the STA includes a frame that does not require an immediate response.
  <Listen>
  The MAC layer of STA 1 has not received a PHY-RXSTART.indication
primitive from the PHY layer and has not transmitted a PHY-TXSTART.request
primitive, the MAC layer of STA 1 has not received a PHY-TXSTART.confirm
primitive from the PHY layer, no nonempty transmit queue exists at STA 1, and STA 1
has not intended to transmit a frame or scheduled a transmission.
```

In the <Listen> condition of Table 4, the MAC layer of STA 1 receiving a PHY-RXSTART.indication primitive from the PHY layer means that STA 1 has detected an incoming frame. The MAC layer of STA 1 transmitting a PHY-TXSTART.request primitive to the PHY layer and the MAC layer of STA 1 receiving a PHY-TXSTART.confirm primitive from the PHY layer may indicate that STA 1 is about to initiate frame transmission.

STA 1 may receive an MU-RTS triggered TXOP sharing (TXS) trigger frame from AP 1 after a SIFS duration. Accordingly, the MAC layer of STA 1 may receive a PHY-RXSTART.indication from the PHY layer, which does not satisfy the <Listen> condition, and therefore STA 1 continues to perform the normal transmission and reception operation without returning to the listen operation. The MU-RTS TXS trigger frame is a frame indicating that AP 1 is sharing the TXOP of AP 1 with STA 1. The MU-RTS TXS trigger frame includes the association identifier (AID) of STA 1, the length of the allocated time during which STA 1 may transmit data frames, and a TXS sharing mode indicator. When the TXS sharing mode indicator is set to 1, STA 1 may transmit frames only to the AP (e.g., AP 1) with which STA 1 is associated within the allocated time. When the TXS sharing mode indicator is set to 2, STA 1 may transmit frames to AP 1 and other STAs (e.g., other STAs not affiliated with the EMLSR STA MLD) within the allocated time. STA 1 may transmit a CTS frame after a SIFS duration from receipt of the MU-RTS TXS trigger frame. STA 1 checks whether the <Listen> condition is satisfied during the Tw duration from the completion of transmission of the CTS frame. If the <Listen> condition is not satisfied during the Tw duration, STA 1 does not transition to the listen operation and continues to perform the normal transmission and reception operation. STA 1 may be required to transmit a data frame within the time allocated by AP 1, and may transmit the data frame after a SIFS duration from the completion of transmission of the CTS frame.

When the TXS sharing mode indicator is set to 1, the data frame must be transmitted only to AP 1, and when the TXS sharing mode indicator is set to 2, the data frame may be transmitted to AP 1 or another STA (e.g., STA 3). Accordingly, when STA 1 initiates data frame transmission, within the Tw duration, the MAC layer of STA 1 transmits a PHY-TXSTART.request primitive to the PHY layer and the MAC layer of STA 1 receives a PHY-TXSTART.confirm primitive from the PHY layer, and therefore the <Listen> condition is not satisfied, and STA 1 does not return to the listen operation but operates in the normal transmission and reception operation. The frame transmitted by STA 1 to AP 1 may be transmitted with an ACK policy set to “No ACK,” which does not request an immediate response, or “Normal ACK” or “Implicit BAR,” which request an immediate response. In the case of a frame transmitted with “Normal ACK” or “Implicit BAR” requesting an immediate response, the STA corresponding to the receiver of the frame (e.g., AP 1 or another STA when the TXS sharing mode indicator is set to 2) transmits a response frame that is an immediate response after a SIFS duration from receipt of the frame. The response frame may be a BlockAck frame or an ACK frame.

STA 1 receives an ACK or BlockAck that is an immediate response; however, since an ACK or BlockAck is a frame that does not require an immediate response, the reception of an ACK or BlockAck corresponds to <Tw Condition 2> “Starts at the completion of reception of a PPDU when the PPDU received from the AP or another STA includes a frame that does not require an immediate response,” and therefore Tw starts at the completion of reception of the PPDU including the ACK or BlockAck. In the case of “No ACK” that does not request an immediate response, STA 1 transmits to AP 1 a frame for which AP 1 does not need to transmit an immediate response frame. The response frame may be a BlockAck frame or an ACK frame. When STA 1 transmits to AP 1 a frame for which a response frame does not need to be transmitted, this satisfies <Tw Condition 3> “Starts at the completion of transmission of a PPDU when the PPDU transmitted by the STA includes a frame that does not require an immediate response,” and therefore the Tw duration starts after transmitting the frame to AP 1.

STA 1 may not expect to receive a response frame from AP 1, and STA 1 checks whether the <Listen> condition is satisfied during the Tw duration from the completion of frame transmission. If the <Listen> condition is not satisfied during the Tw duration, STA 1 does not transition to the listen operation and continues to perform the normal transmission and reception operation. STA 1 may be required to additionally transmit data frames within the time allocated by AP 1, and the additional data frame of STA 1 may be a frame that returns the allocated time in TXS mode 2 to AP 1 (e.g., a QoS data frame or a QoS Null frame including a CAS control subfield). The HT control field included in the MAC header of the additional data frame of STA 1 may include a CAS control subfield in A-control format. The CAS control subfield may include an RDG/more PPDU bit, and when this bit is set to 0, STA 1 returns the allocated time to AP 1. STA 1 may no longer transmit frames within the allocated time to AP 1 after transmitting the additional frame. The additional data frame transmitted by STA 1 may be transmitted with the ACK policy set to No ACK. That is, STA 1 transmits to AP 1 a frame for which AP 1 does not need to transmit a response frame.

The response frame may be a BlockAck frame or an ACK frame. When STA 1 transmits to AP 1 a frame for which a response frame does not need to be transmitted, this satisfies <Tw Condition 3> “Starts at the completion of transmission of a PPDU when the PPDU transmitted by the STA includes a frame that does not require an immediate response,” and therefore the Tw duration starts after transmitting the frame to AP 1. The frame transmitted by STA 1 that does not require a response frame to be transmitted may be, in addition to a frame with the ACK policy set to No ACK, a frame that does not request an ACK (i.e., a response frame), such as an Action No ACK frame.

STA 1 may not expect to receive a response frame from AP 1, and STA 1 checks whether the <Listen> condition is satisfied during the Tw duration from the completion of frame transmission. If STA 1 does not satisfy the <Listen> condition, STA 1 does not operate in the listen operation and continues to perform the normal transmission and reception operation. However, STA 1 may wish to no longer transmit frames, and therefore the MAC layer of STA 1 may not transmit a PHY-TXSTART.request primitive, and the MAC layer of STA 1 may not receive a PHY-TXSTART.confirm primitive from the PHY layer. AP 1 may not transmit frames to STA 1, and therefore the MAC layer of STA 1 may not receive a PHY-RXSTART.indication primitive. Accordingly, since the <Listen> condition is satisfied, STA 1 and STA 2 may operate in the listen operation after the Tt duration has elapsed following the Tw duration. The Tt duration is the time for STA MLD 1 affiliated with STA 1 to switch the radio chain.

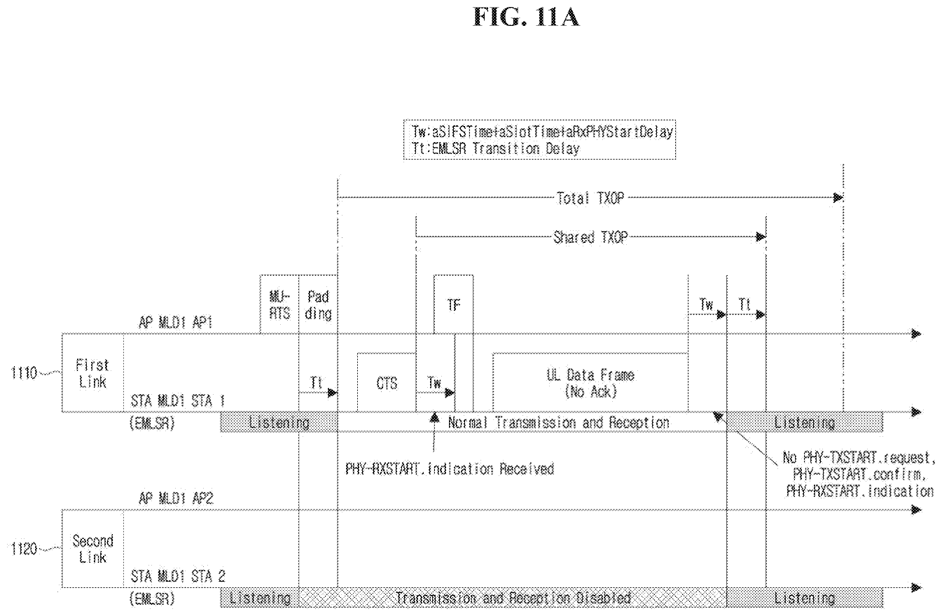

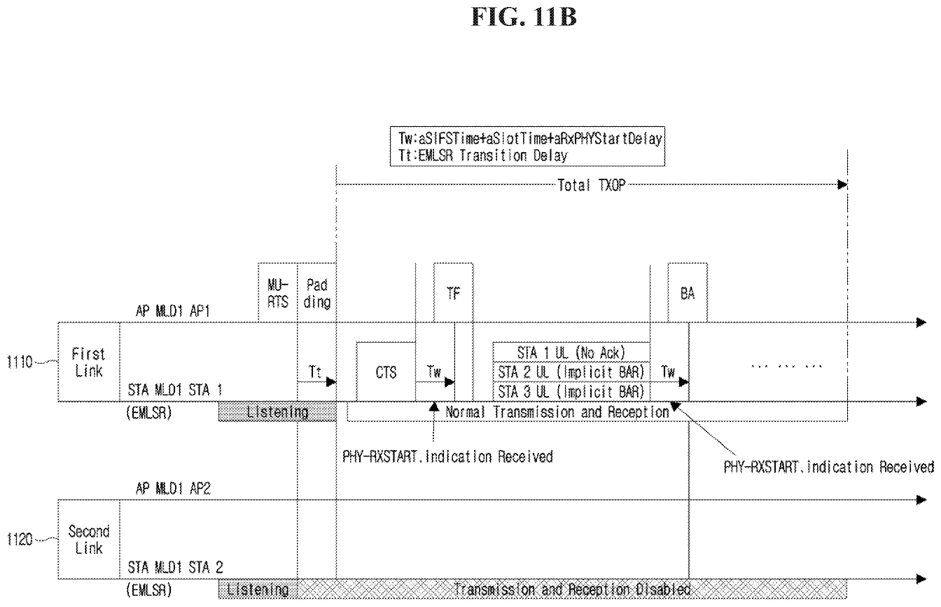

FIG. 11A and FIG. 11B are diagrams illustrating a frame exchange method during enhanced multi-link single radio operation of a wireless LAN to which the present disclosure is applied. Referring to FIG. 11A and FIG. 11B, the AP operating on the first link (1110) of AP MLD 1 may be referred to as AP 1, and the AP operating on the second link (1120) may be referred to as AP 2. The STA operating on the first link (1110) of STA MLD 1 may be referred to as STA 1, and the STA operating on the second link (1120) of STA MLD 1 may be referred to as STA 2. In addition, STA MLD 1 may be an enhanced multi-link single radio (EMLSR) STA MLD.

The EMLSR STA MLD may perform EMLSR operation, and STA MLD 1 may perform EMLSR operation on the first link (1110) and the second link (1120). STAs on each link of STA MLD 1 may be referred to as EMLSR STAs. In an embodiment, STA 1, which is the STA of EMLSR STA MLD 1 operating on the first link (1110), may be referred to as an EMLSR STA. The EMLSR STA MLD may initiate or terminate the EMLSR operation or mode by exchanging an EML operating mode notification (OMN) frame with the AP MLD.

Before the EMLSR mode is terminated or initiated, at a given time, either STA 1 or STA 2 may perform normal transmission and reception operations and a listen operation using one transceiver (e.g., a radio). Here, STA 1 and STA 2 may not simultaneously perform normal transmission and reception operations. When the EMLSR STA MLD initiates the EMLSR mode through EML OMN frame exchange, it may perform EMLSR mode operation on the EMLSR links negotiated with the AP MLD. The EMLSR mode operation consists of a listen operation (e.g., listening operation) that listens for whether an initial control frame of a predetermined format is being transmitted on the EMLSR links, and a normal transmission and reception operation (e.g., EMLSR operation) that transitions all receiving radios (e.g., receiving antennas) or transceiving radios (e.g., transceiving antennas) operating on other links to the link on which the initial control frame was transmitted, and receives frames transmitted from the AP MLD.

When the EMLSR STA MLD transmits to the AP MLD, it may transition all radios to one of the EMLSR links for transmission. STA 1 may perform normal transmission and reception operations and a listen operation. STA 1 may transmit and receive all frames in the normal transmission and reception operation. STA 1 may receive only frames of a predetermined format in the listen operation. The frame of a predetermined format may be an initial control frame. The initial control frame may be an MU-RTS trigger frame or a BSRP trigger frame. The MU-RTS trigger frame may also be referred to as an MU-RTS frame in the present disclosure. STA 2 affiliated with EMLSR STA MLD 1 may operate in a listen operation when the operational state of STA 1 is the listen operation. When the operational state of STA 1 is the normal transmission and reception operation, STA 2 may be in a transmission and reception disabled state. During the transition time Tt required when STA 1 transitions from the listen operation to the normal transmission and reception operation, or from the normal transmission and reception operation to the listen operation, STA 2 may be in a transmission and reception disabled state. The operational state changes may be equally applicable to STA 1 when STA 2 is in the listen operation or the normal transmission and reception operation.

On the first link, AP 1 may perform a channel access operation (e.g., EDCA backoff operation) to acquire a TXOP, which is a time interval during which a plurality of frames may be transmitted. On the first link, STA 1 may receive an initial control frame (e.g., an MU-RTS trigger frame). The initial control frame may include padding bits and/or a padding field that extends the length of the frame in consideration of the radio switching time of STA 1. STA 1 may respond with a CTS frame after a SIFS duration from the completion of reception of the initial control frame. At this time, STA 1 may wait for a Tw duration. The Tw duration is a duration consisting of ‘aSIFSTime+aSlotTime+aRxPHYStartDelay’. The aRxPHYStartDelay may be 20 μs.

The Tw duration may start when one of the following conditions, <Tw Condition 1>, <Tw Condition 2>, and <Tw Condition 3> in Table 5 below, is satisfied after the reception of the initial control frame. In an embodiment, in the <Listen> condition of Table 5, the MAC layer of STA 1 receiving a PHY-RXSTART.indication primitive from the PHY layer means that STA 1 has detected an incoming frame. The MAC layer of STA 1 transmitting a PHY-TXSTART.request primitive to the PHY layer and the MAC layer of STA 1 receiving a PHY-TXSTART.confirm primitive from the PHY layer means that STA 1 is about to initiate frame transmission.

```
TABLE 5
  <Tw Condition 1>
  Starts at the completion of transmission of a PPDU when the PPDU transmitted
by the STA is a response to the most recently received frame from the AP.
  <Tw Condition 2>
  Starts at the completion of reception of a PPDU when the PPDU received from
the AP or another STA includes a frame that does not require an immediate response.
  <Tw Condition 3>
  Starts at the completion of transmission of a PPDU when the PPDU transmitted
by the STA includes a frame that does not require an immediate response.
  When Tw is initiated after the completion of reception of the initial control
frame, STA 1 may not operate in the normal transmission and reception operation and
may transition to the listen operation if the <Listen> condition is satisfied during the Tw
duration.
  <Listen>
  The MAC layer of STA 1 has not received a PHY-RXSTART.indication
primitive from the PHY layer and has not transmitted a PHY-TXSTART.request
primitive, the MAC layer of STA 1 has not received a PHY-TXSTART.confirm
primitive from the PHY layer, no nonempty transmit queue exists at STA 1, and STA 1
has not intended to transmit a frame or scheduled a transmission.
```

STA 1 may receive a trigger frame from AP 1 after a SIFS duration. The trigger frame is a basic trigger frame. Accordingly, the MAC layer of STA 1 may receive a PHY-RXSTART.indication from the PHY layer, which does not satisfy the <Listen> condition, and therefore STA 1 continues to perform the normal transmission and reception operation without returning to the listen operation. The trigger frame is a frame indicating that AP 1 is allocating uplink resources for STA 1. The trigger frame includes the association identifier (AID) of STA 1, an uplink (UL) length indicating the duration during which STA 1 may transmit data frames, and resource information for uplink transmission by STA 1 (e.g., resource unit (RU) information, which is an orthogonal frequency division multiple access (OFDMA) resource). An uplink data frame may be transmitted to AP 1 after a SIFS duration from receipt of the trigger frame.

The uplink data frame is transmitted in an uplink trigger-based (UL TB) PPDU (physical layer protocol data unit) format. The UL TB PPDU may be a response frame to the trigger frame of AP 1. At this time, the uplink data frame transmitted by STA 1 may be transmitted with an ACK policy set to “No ACK,” which does not request an immediate response, or “Normal ACK” or “Implicit BAR,” which request an immediate response. In the case of a frame transmitted with “Normal ACK” or “Implicit BAR” requesting an immediate response, the STA corresponding to the receiver of the frame (e.g., AP 1 or another STA when the TXS sharing mode indicator is set to 2) transmits a response frame that is an immediate response after a SIFS duration from receipt of the frame.

The response frame may be a BlockAck frame or an ACK frame. STA 1 receives an ACK or BlockAck that is an immediate response; however, since an ACK or BlockAck is a frame that does not require an immediate response, the reception of an ACK or BlockAck corresponds to <Tw Condition 2> “Starts at the completion of reception of a PPDU when the PPDU received from the AP or another STA includes a frame that does not require an immediate response,” and therefore Tw starts at the completion of reception of the PPDU including the ACK or BlockAck.

In the case of “No ACK” that does not request an immediate response, STA 1 transmits to AP 1 a frame for which AP 1 does not need to transmit an immediate response frame. The response frame may be a BlockAck frame or an ACK frame. When STA 1 transmits to AP 1 a frame for which a response frame does not need to be transmitted, this satisfies <Tw Condition 3> “Starts at the completion of transmission of a PPDU when the PPDU transmitted by the STA includes a frame that does not require an immediate response,” and therefore the Tw duration starts after transmitting the frame to AP 1. The frame transmitted by STA 1 that does not require a response frame to be transmitted may be, in addition to a frame with the ACK policy set to No ACK, a frame that does not request an ACK, such as an Action No ACK frame.

Referring to FIG. 11A, STA 1 checks whether the <Listen> condition is satisfied during the Tw duration from the completion of transmission of the uplink data frame. The ACK policy of the uplink data transmitted by STA 1 to AP 1 was set to No ACK for transmission. That is, STA 1 transmitted a frame that does not require an immediate response frame. Alternatively, the frame transmitted by STA 1 may be a frame that does not require a response frame, such as an Action No ACK frame. Accordingly, when STA 1 transmits to AP 1 a frame for which a response frame does not need to be transmitted, this satisfies <Tw Condition 3> “Starts at the completion of transmission of a PPDU when the PPDU transmitted by the STA includes a frame that does not require an immediate response,” and therefore the Tw duration starts after transmitting the frame to AP 1. If the <Listen> condition is not satisfied during the Tw duration, STA 1 does not transition to the listen operation and continues to perform the normal transmission and reception operation. STA 1 may receive an additional frame (e.g., a data frame, a trigger frame, etc.) from AP 1 after a SIFS duration from the completion of transmission of the uplink data frame. In this case, the MAC layer of STA 1 receives a PHY-RXSTART.indication primitive from the PHY layer. Accordingly, the <Listen> condition may not be satisfied within the Tw duration for STA 1. Therefore, STA 1 may operate in the normal transmission and reception operation without transitioning to the listen operation. Alternatively, STA 1 may not receive an additional frame (e.g., a data frame, a trigger frame, etc.) from AP 1 after a SIFS duration from the completion of transmission of the uplink data frame, and STA 1 may not transmit a frame to AP 1. In this case, STA 1 satisfies the <Listen> condition within the Tw duration. Accordingly, STA 1 and STA 2 may transition to and operate in the listen operation after the Tt duration has elapsed following the Tw duration. The Tt duration is the time for STA MLD 1 affiliated with STA 1 to switch the radio chain.

Referring to FIG. 11B, AP 1 may have allocated uplink resources to STAs other than STA 1 in the trigger frame as well. Accordingly, after a SIFS duration from the end of the trigger frame of AP 1, STA 1 and other STAs may transmit frames to AP 1 using UL OFDMA (i.e., multi-user) transmission. STA 1 checks whether the <Listen> condition is satisfied during the Tw duration from the completion of transmission of the uplink data frame. The ACK policy of the uplink data transmitted by STA 1 to AP 1 was set to No ACK for transmission. That is, STA 1 transmitted a frame that does not require an immediate response frame. Accordingly, when STA 1 transmits to AP 1 a frame for which a response frame does not need to be transmitted, this satisfies <Tw Condition 3> “Starts at the completion of transmission of a PPDU when the PPDU transmitted by the STA includes a frame that does not require an immediate response,” and therefore the Tw duration starts after transmitting the frame to AP 1. At least one STA among the STAs other than STA 1 may have transmitted a frame requesting a response frame from the AP (e.g., a frame including a Normal ACK or Implicit BAR ACK policy).

If the <Listen> condition is not satisfied during the Tw duration, STA 1 does not operate in the listen operation and continues to perform the normal transmission and reception operation. Even when the ACK policy of the uplink data frame of STA 1 is set to No ACK, or when the uplink frame is a frame that does not require a response frame such as an Action No ACK frame, AP 1 may transmit a response frame because STAs other than STA 1 transmitted frames requesting a response frame. The response frame may be transmitted after a SIFS duration from the completion of transmission of the uplink data frames of STA 1 and other STAs. In this case, the MAC layer of STA 1 receives a PHY-RXSTART.indication primitive from the PHY layer. Accordingly, the <Listen> condition may not be satisfied within the Tw duration for STA 1. Therefore, STA 1 may operate in the normal transmission and reception operation without transitioning to the listen operation. The response frame may be an ACK frame or a BlockAck frame.

FIG. 10, FIG. 11A, and FIG. 11B illustrate that the EMLSR operation of STA 1 may operate based on the machine learning unit and machine learning algorithm of FIG. 3 and FIG. 4. In an embodiment, a machine learning algorithm may be used for the PHY layer of STA 1 to determine whether to transmit or receive a frame. The PHY layer of STA 1 may input the received signal to the machine learning unit to determine whether the EMLSR operation should be performed based on the received signal. The machine learning unit may use the machine learning algorithm to determine whether the signal received at the PHY layer is a wireless LAN physical layer preamble conforming to the IEEE 802.11 standard. When the received signal is a wireless LAN physical layer preamble conforming to the IEEE 802.11 standard, the PHY layer of STA 1 may transmit a PHY-RXSTART.indication_ml primitive to the MAC layer. The PHY-RXSTART.indication_ml primitive may perform the same role as the PHY-RXSTART.indication primitive, but may be transmitted when the primitive is generated based on a machine learning unit or algorithm.

According to an embodiment of the present disclosure, the first STA performs a pre-negotiation procedure with a second STA for configuring a transmission mode for data requiring reduced channel access delay. The first STA transmits to the second STA at least one piece of information regarding a state in which the data is input. At this point, whether transmission by the first STA is required is indicated based on the transmission of the at least one piece of information. The first STA performs an additional operation within a transmission opportunity (TXOP) of the second STA based on whether transmission is required. According to an embodiment of the present disclosure, the first STA is a STA in which a transmission operation for the data is activated based on the pre-negotiation procedure. According to an embodiment of the present disclosure, the pre-negotiation procedure is performed based on frame exchange between the first STA and the second STA, and at least one parameter related to the data transmission is determined. According to an embodiment of the present disclosure, a first parameter among the at least one parameter indicates whether traffic is the data requiring reduced channel access delay. At this point, traffic for which the first parameter has a first value is determined as the data. According to an embodiment of the present disclosure, traffic input to the first STA is the data requiring reduced channel access delay for which the first parameter is set to the first value, and the at least one piece of information regarding the state in which the data is input is transmitted from the first STA to the second STA. According to an embodiment of the present disclosure, a condition for mapping or restricting the data requiring reduced channel access delay to a specific access category (AC) associated with delay sensitive is determined through the pre-negotiation procedure. According to an embodiment of the present disclosure, the first STA performs at least one frame exchange with the second STA after the pre-negotiation procedure, and the at least one piece of information is included in a frame transmitted by the first STA to the second STA based on the at least one frame exchange being performed. According to an embodiment of the present disclosure, the at least one piece of information is included as a field in the frame transmitted by the first STA to the second STA. At this point, the field indicates whether the data is input. According to an embodiment of the present disclosure, the field indicating whether the data is input is a 1-bit indicator, and the first STA sets the field to a first value and transmits the field when the data exists, and then performs the additional operation within the TXOP of the second STA. According to an embodiment of the present disclosure, the first STA performs, as the additional operation within the TXOP of the second STA, an operation of transmitting the data to the second STA connected to the first STA. According to an embodiment of the present disclosure, the first STA performs, as the additional operation within the TXOP of the second STA, an operation of transmitting the data to a third STA neighboring the first STA. According to an embodiment of the present disclosure, the at least one piece of information includes buffer status report (BSR) information of the first STA or feedback field information within a response frame. According to an embodiment of the present disclosure, the additional operation is a TXOP sharing operation, and the TXOP sharing operation includes a reverse direction (RD) operation. According to an embodiment of the present disclosure, the field is a 1-bit indicator that indicates whether the input data is uplink traffic destined for the second STA or peer-to-peer traffic destined for a third STA. According to an embodiment of the present disclosure, the at least one frame exchange includes an operation of receiving a control frame that induces transmission from the second STA and an operation of transmitting a block acknowledgment (BlockAck) frame to the second STA as a response frame to the received control frame, and the at least one piece of information is included within the block acknowledgment frame. According to an embodiment of the present disclosure, the second STA is a TXOP holder of the TXOP, transmission by the second STA within the TXOP is adjusted based on the at least one piece of information received from the first STA, and the additional operation by the first STA is performed within the TXOP. According to an embodiment of the present disclosure, when the at least one piece of information has a second value indicating that the data is not been input, resource allocation for the first STA is omitted or the acquired TXOP interval is truncated by the second STA. According to an embodiment of the present disclosure, resources allocated to the first STA and an allocation time within the acquired TXOP are adjusted by the second STA based on the at least one piece of information received from the first STA. According to an embodiment of the present disclosure, the first STA is a non-access point (AP) STA or an AP STA.

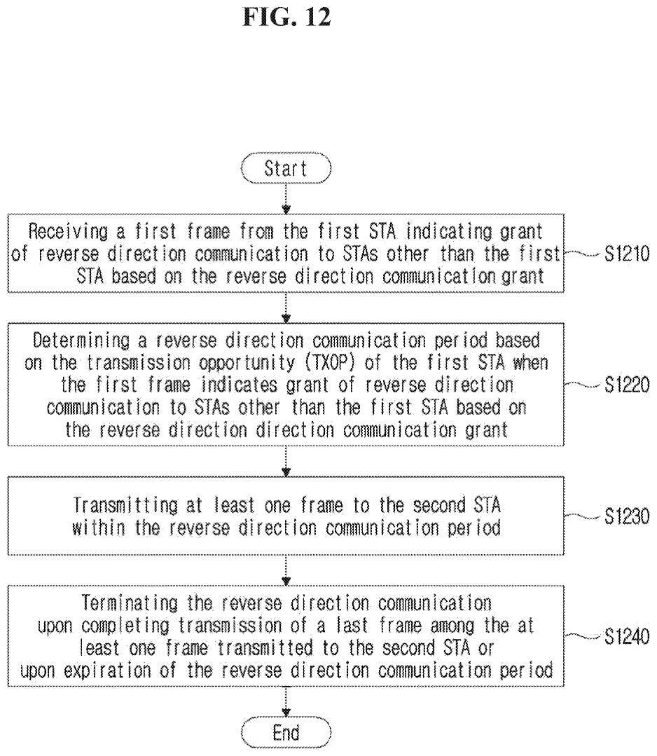

FIG. 12 is a flowchart illustrating a method of operating an AP performing reverse direction transmission in a wireless LAN to which the present disclosure is applied. Referring to FIG. 12, the AP may receive a first frame from a first STA indicating grant of reverse direction communication to STAs other than the first STA based on the reverse direction communication grant. (S1210) In an embodiment, the first frame may be an uplink frame transmitted by the first STA to the AP, but is not limited thereto. When the first frame indicates grant of reverse direction communication and indicates grant of reverse direction communication to STAs other than the first STA based on the reverse direction communication grant, the AP may determine a reverse direction communication period based on the TXOP of the first STA. (S1220) The AP may transmit at least one frame to a second STA within the reverse direction communication period (S1230), and may terminate the reverse direction communication upon completing transmission of a last frame among the at least one frame transmitted to the second STA or upon expiration of the reverse direction communication period. (S1240) In an embodiment, the first STA may be a STA that grants reverse direction communication to the AP, and the second STA may be the first STA or another STA, and is not limited to any specific form. In an embodiment, the AP may include at least one processor and a memory storing instructions that cause the wireless user equipment to perform certain operations by the at least one processor, and may perform the operations based thereon.

In addition, In an embodiment, the AP may initiate reverse direction communication by transmitting a response frame including information indicating initiation of reverse direction communication to the first STA, and when the AP transmits at least one frame to a second STA different from the first STA based on the RDGO indicator, the at least one frame may include a more data indicator indicating whether a subsequent frame to be transmitted exists, and a last frame among the at least one frame may be identified based on the more data indicator. The AP may transmit the last frame including, in a frame header thereof, duration information for receiving a response frame from the second STA, and may terminate reverse direction communication based on the duration information. The first STA may receive the last frame even when the receiver address of the last frame is not the first STA, and may confirm whether the AP transmits the last frame and the termination timing of the reverse direction communication based on the duration information. When the TXOP of the first STA remains after the termination timing of the reverse direction communication, the first STA may transmit frames to other STAs through the TXOP of the first STA.

In addition, In an embodiment, when the AC restriction indicator permits transmission of data having an AC different from the AC of the first STA data in the reverse direction communication, and the TXOP extension grant indicator permits extension of the reverse direction communication period, the AP may determine the reverse direction communication period as the TXOP corresponding to the AC of a second frame transmitted to the second STA when the TXOP corresponding to the AC of the second frame is longer than the TXOP of the first STA. On the other hand, when the TXOP corresponding to the AC of the second frame transmitted to the second STA is shorter than the TXOP of the first STA, the AP may determine the TXOP of the first STA as the reverse direction communication period, as described above. In addition, In an embodiment, the start time of the TXOP corresponding to the AC of the second frame may be determined as the start time of the TXOP of the first STA or the start time of the reverse direction communication. Here, the second frame may be any frame and may not be limited to any specific form.

In addition, In an embodiment, the first frame may further include frame segmentation related information, and the AP may transmit at least one frame to the second STA according to a segmented frame length indicated based on the frame segmentation related information. Here, the at least one frame transmitted based on the segmented frame length may be transmitted at a priority inter-frame space (PIFS) interval that is longer than a short inter-frame space (SIFS). In addition, when the first STA transmits an RD revoke request frame to the AP, the reverse direction communication revoke request frame may be transmitted after a SIFS duration from the transmission end time of a second frame among the at least one frame, and upon receiving the reverse direction communication revoke request frame, the AP may transmit a frame indicating suspend of reverse direction communication use to the second STA after a SIFS duration, or may immediately terminate the reverse direction communication.

In addition, the acknowledgment policy (ACK policy) of the frame indicating suspend of reverse direction communication use may be set to acknowledgment required, and the second STA receiving the frame indicating suspend of reverse direction communication use may transmit a response frame to the frame indicating suspend of reverse direction communication use to the AP after a SIFS duration from receipt of the frame indicating suspend of reverse direction communication use based on the ACK policy, and upon receiving the response frame, the AP may terminate the reverse direction communication. In addition, when the AP transmits at least one multi-user (MU) frame to a plurality of STAs including the second STA according to a segmented frame length indicated based on the frame segmentation related information, upon receiving the reverse direction communication revoke request frame, the AP may transmit an MU frame indicating suspend of reverse direction communication use to the plurality of STAs including the second STA after a SIFS duration, or may immediately terminate the reverse direction communication. Here, the MU frame may indicate subchannel information on which the plurality of STAs including the second STA are to transmit response frames to the MU frame.

In addition, the AP may perform a reverse direction communication membership negotiation procedure with at least one of the first STA or STAs capable of providing reverse direction communication, and may determine a reverse direction communication STA based on the reverse direction communication membership negotiation procedure. In an embodiment, the reverse direction communication membership negotiation procedure may determine at least one of: reverse direction operation participation level information indicating whether the reverse direction communication STA mandatorily participates in the reverse direction communication operation; reverse direction operation participation duration information indicating a membership status maintenance duration of the reverse direction communication STA; and reverse direction communication related parameters, as described above. In addition, the AP may transmit, to the reverse direction communication STA determined based on the reverse direction communication negotiation procedure, a buffer status report (BSR) including at least one of: total data size information present in a queue of the AP; per-AC data size information; and transmission duration information in the reverse direction communication. The reverse direction communication STA determined based on the reverse direction communication negotiation procedure may perform an enhanced distributed channel access (EDCA) backoff operation for use of reverse direction communication by the AP even when no packet exists in the transmission queue after a backoff. In addition, when a multi-user (MU) EDCA parameter configured to cause channel occupancy with a lower probability is set for the reverse direction communication STA determined based on the reverse direction communication negotiation procedure, the reverse direction communication STA may not apply the MU EDCA parameter or may apply a separate EDCA parameter for the reverse direction communication STA during the period in which the reverse direction communication membership status is maintained based on the reverse direction operation participation duration information.

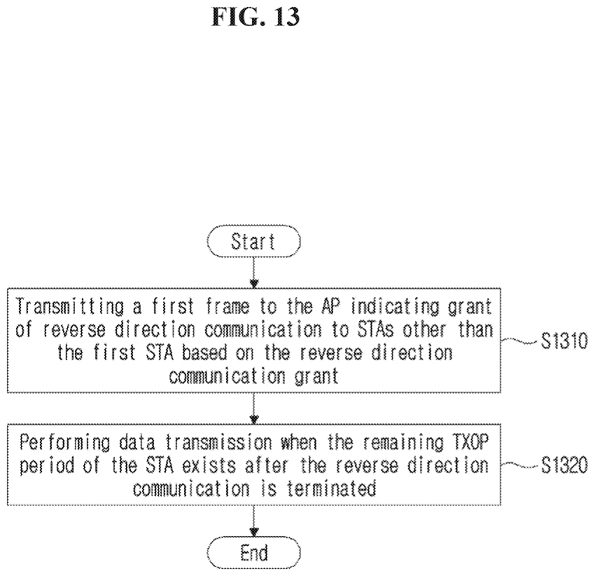

FIG. 13 is a flowchart illustrating a method of operating a STA authorizing reverse direction transmission in a wireless LAN to which the present disclosure is applied. The STA may transmit a first frame to the AP indicating grant of reverse direction communication to STAs other than the STA based on the reverse direction communication grant. (S1310) Here, when the first frame indicates grant of reverse direction communication, the reverse direction communication period may be determined at the AP based on the TXOP of the STA. The AP may transmit at least one frame to the STA or another STA within the reverse direction communication period, and may perform data transmission when the remaining TXOP period of the STA exists after the reverse direction communication is terminated upon completing transmission of a last frame among the at least one frame transmitted to the other STA or upon expiration of the reverse direction communication period. (S1320) Here, the STA may include at least one processor and a memory storing instructions that cause the wireless user equipment to perform certain operations by the at least one processor, and may perform the operations.

In an embodiment, the AP may initiate reverse direction communication by transmitting a response frame including information indicating initiation of reverse direction communication to the STA, and when the AP transmits at least one frame to a STA different from the STA based on the RDGO indicator, the at least one frame may include a more data indicator indicating whether a subsequent frame to be transmitted exists, and a last frame among the at least one frame may be identified based on the more data indicator. The AP may transmit the last frame including, in a frame header thereof, duration information for receiving a response frame from the other STA, and may terminate reverse direction communication based on the duration information. The STA may receive the last frame even when the receiver address of the last frame is not the STA, and may confirm whether the AP transmits the last frame and the termination timing of the reverse direction communication based on the duration information. When the TXOP of the STA remains after the termination timing of the reverse direction communication, the STA may transmit frames to other STAs through the TXOP of the STA, as described above.

In addition, In an embodiment, when the AC restriction indicator permits transmission of data having an AC different from the AC of the STA data in the reverse direction communication, and the TXOP extension grant indicator permits extension of the reverse direction communication period, the AP may determine the reverse direction communication period as the TXOP corresponding to the AC of a second frame transmitted to the other STA when the TXOP corresponding to the AC of the second frame is longer than the TXOP of the STA. On the other hand, when the TXOP corresponding to the AC of the second frame transmitted to the other STA is shorter than the TXOP of the STA, the AP may determine the TXOP of the STA as the reverse direction communication period, as described above. In addition, In an embodiment, the start time of the TXOP corresponding to the AC of the second frame may be determined as the start time of the TXOP of the STA or the start time of the reverse direction communication. Here, the second frame may be any frame and may not be limited to any specific form.

In addition, In an embodiment, the first frame may further include frame segmentation related information, and the AP may transmit at least one frame to the other STA according to a segmented frame length indicated based on the frame segmentation related information. Here, the at least one frame transmitted based on the segmented frame length may be transmitted at a priority inter-frame space (PIFS) interval that is longer than a short inter-frame space (SIFS). In addition, when the STA transmits an RD revoke request frame to the AP, the reverse direction communication revoke request frame may be transmitted after a SIFS duration from the transmission end time of a second frame among the at least one frame, and upon receiving the reverse direction communication revoke request frame, the AP may transmit a frame indicating suspend of reverse direction communication use to the STA after a SIFS duration, or may immediately terminate the reverse direction communication.

In addition, the acknowledgment policy (ACK policy) of the frame indicating suspend of reverse direction communication use may be set to acknowledgment required, and the other STA receiving the frame indicating suspend of reverse direction communication use may transmit a response frame to the frame indicating suspend of reverse direction communication use to the AP after a SIFS duration from receipt of the frame indicating suspend of reverse direction communication use based on the ACK policy, and upon receiving the response frame, the AP may terminate the reverse direction communication. In addition, when the AP transmits at least one multi-user (MU) frame to a plurality of STAs including the other STA according to a segmented frame length indicated based on the frame segmentation related information, upon receiving the reverse direction communication revoke request frame, the AP may transmit an MU frame indicating suspend of reverse direction communication use to the plurality of STAs including the other STA after a SIFS duration, or may immediately terminate the reverse direction communication. Here, the MU frame may indicate subchannel information on which the plurality of STAs including the other STA are to transmit response frames to the MU frame.

In addition, the AP may perform a reverse direction communication membership negotiation procedure with at least one of the STA or STAs capable of providing reverse direction communication, and may determine a reverse direction communication STA based on the reverse direction communication membership negotiation procedure. In an embodiment, the reverse direction communication membership negotiation procedure may determine at least one of: reverse direction operation participation level information indicating whether the reverse direction communication STA mandatorily participates in the reverse direction communication operation; reverse direction operation participation duration information indicating a membership status maintenance duration of the reverse direction communication STA; and reverse direction communication related parameters, as described above. In addition, the AP may transmit, to the reverse direction communication STA determined based on the reverse direction communication negotiation procedure, a buffer status report (BSR) including at least one of: total data size information present in a queue of the AP; per-AC data size information; and transmission duration information in the reverse direction communication. The reverse direction communication STA determined based on the reverse direction communication negotiation procedure may perform an enhanced distributed channel access (EDCA) backoff operation for use of reverse direction communication by the AP even when no packet exists in the transmission queue after a backoff. In addition, when a multi-user (MU) EDCA parameter configured to cause channel occupancy with a lower probability is set for the reverse direction communication STA determined based on the reverse direction communication negotiation procedure, the reverse direction communication STA may not apply the MU EDCA parameter or may apply a separate EDCA parameter for the reverse direction communication STA during the period in which the reverse direction communication membership status is maintained based on the reverse direction operation participation duration information.

The methods according to the present disclosure may be implemented in the form of program instructions executable by various computer means and recorded on a computer-readable medium. The computer-readable medium may include program instructions, data files, data structures, and the like, alone or in combination. The program instructions recorded on the computer-readable medium may be those specially designed and configured for the present disclosure, or may be those known and available to those skilled in the art of computer software.

Embodiments of the computer-readable medium include hardware devices specially configured to store and execute program instructions, such as ROM, RAM, and flash memory. Embodiments of program instructions include not only machine language code generated by a compiler, but also high-level language code executable by a computer using an interpreter or the like. The hardware devices may be configured to operate as at least one software module to perform the operations of the present disclosure, and vice versa.

Although the present disclosure has been described with reference to the embodiments above, those skilled in the art will understand that the present disclosure may be variously modified and changed without departing from the spirit and scope of the present disclosure as set forth in the claims below.

### INDUSTRIAL APPLICABILITY

The foregoing may also be applicable to other systems.

1-17. (canceled)

18. A method of operating a first station (STA) in a wireless LAN system, the method comprising:
performing, by the first STA, a pre-negotiation procedure with a second STA for configuring a transmission mode for data requiring reduced channel access delay;
transmitting, by the first STA to the second STA, at least one piece of information regarding a state in which the data is input, wherein whether transmission by the first STA is required is indicated based on the transmission of the at least one piece of information; and
performing, by the first STA, an additional operation within a transmission opportunity (TXOP) of the second STA based on whether transmission is required.

19. The method of claim 18,
wherein the first STA is a STA in which a transmission operation for the data is activated based on the pre-negotiation procedure.

20. The method of claim 19,
wherein the pre-negotiation procedure is performed based on frame exchange between the first STA and the second STA, and at least one parameter related to the data transmission is determined.

21. The method of claim 20,
wherein a first parameter among the at least one parameter indicates whether traffic is the data requiring reduced channel access delay, and
wherein traffic for which the first parameter has a first value is determined as the data.

22. The method of claim 21,
wherein traffic input to the first STA is the data requiring reduced channel access delay for which the first parameter is set to the first value, and the at least one piece of information regarding the state in which the data is input is transmitted from the first STA to the second STA.

23. The method of claim 20,
wherein a condition for mapping or restricting the data requiring reduced channel access delay to a specific access category (AC) associated with delay sensitivity is determined through the pre-negotiation procedure.

24. The method of claim 18,
wherein the first STA performs at least one frame exchange with the second STA after the pre-negotiation procedure, and the at least one piece of information is included in a frame transmitted by the first STA to the second STA based on the at least one frame exchange being performed.

25. The method of claim 24,
wherein the at least one piece of information is included as a field in the frame transmitted by the first STA to the second STA, the field indicating whether the data is input.

26. The method of claim 25,
wherein the field indicating whether the data is input is a 1-bit indicator, and the first STA sets the field to a first value and transmits the field when the data exists, and then performs the additional operation within the TXOP of the second STA.

27. The method of claim 26,
wherein the first STA performs, as the additional operation within the TXOP of the second STA, an operation of transmitting the data to the second STA connected to the first STA.

28. The method of claim 26,
wherein the first STA performs, as the additional operation within the TXOP of the second STA, an operation of transmitting the data to a third STA neighboring the first STA.

29. The method of claim 26,
wherein the at least one piece of information includes buffer status report (BSR) information of the first STA or feedback field information within a response frame.

30. The method of claim 25,
wherein the additional operation is a TXOP sharing operation, and the TXOP sharing operation includes a reverse direction (RD) operation.

31. The method of claim 25,
wherein the field is a 1-bit indicator that indicates whether the input data is uplink traffic destined for the second STA or peer-to-peer traffic destined for a third STA.

32. The method of claim 24,
wherein the at least one frame exchange includes an operation of receiving a control frame that induces transmission from the second STA and an operation of transmitting a block acknowledgment (BlockAck) frame to the second STA as a response frame to the received control frame, and the at least one piece of information is included within the block acknowledgment frame.

33. The method of claim 18,
wherein the second STA is a TXOP holder of the TXOP, transmission by the second STA within the TXOP is adjusted based on the at least one piece of information received from the first STA, and the additional operation by the first STA is performed within the TXOP.

34. The method of claim 33,
wherein when the at least one piece of information has a second value indicating that the data is not input, resource allocation for the first STA is omitted or the acquired TXOP interval is truncated by the second STA.

35. The method of claim 33,
wherein resources allocated to the first STA and an allocation time within the acquired TXOP are adjusted by the second STA based on the at least one piece of information received from the first STA.

36. The method of claim 18,
wherein the first STA is a non-access point (AP) STA or an AP STA.

37. A first station (STA) comprising:
at least one processor; and
a memory storing instructions that cause the first STA to perform specific operations by the at least one processor,
wherein the specific operations comprise:
performing a pre-negotiation procedure with a second STA for configuring a transmission mode for data requiring reduced channel access delay;
transmitting, to the second STA, at least one piece of information regarding a state in which the data is input, wherein whether transmission by the first STA is required is indicated based on the transmission of the at least one piece of information; and
performing an additional operation within a transmission opportunity (TXOP) of the second STA based on whether transmission is required.
